(19) United States
(12) Patent Application Publication
(10) Pub. No.: US 2022/0017773 A1
(43) Pub. Date: Jan. 20, 2022

(54) FILLED RADIATION CURABLE COMPOSITIONS FOR COATING OPTICAL FIBER AND THE COATINGS PRODUCED THEREFROM

(71) Applicant: MS HOLDING B.V., Nieuwegein (NL)

(72) Inventors: Paulus Antonius Maria STEEMAN, ECHT (NL); Mark Petrus Franciscus PEPELS, ECHT (NL); Huimin CAO, ELGIN, IL (US); Kangtai REN, ELGIN, IL (US)

(21) Appl. No.: 17/295,799

(22) PCT Filed: Nov. 29, 2019
(86) PCT No.: PCT/EP2019/083069

§ 371 Date: May 20, 2021

Related U.S. Application Data
(60) Provisional application No. 62/774,576, filed on Dec. 3, 2018.

(51) Int. Cl. C09D 175/14; C09D 7/61; C08G 18/75; C08G 18/48; C08G 18/67; C08G 18/12; C03C 25/105; C03C 25/285; C03C 25/326

(52) U.S. Cl. CPC C09D 175/14; C09D 7/61; C08G 18/755; C08G 18/4825; C03C 25/326; C08G 18/12; C03C 25/105; C03C 25/285; C08G 18/672

(57) ABSTRACT

Described herein are radiation curable compositions for coating optical fibers including a reactive oligomer with at least one polymerizable group and a backbone, a reactive diluent monomer, a photoinitiator, optionally one or more additives, and a filler component. Such compositions are configured to possess specified liquid glass transition temperatures and/or viscosity ratios when measured between 25, 55, and/or 85 degrees Celsius. Also described are compositions wherein the filler component is present in specified amounts and/or sizes, and contains specified types of filler constituents. Also described are optical fibers coated from such compositions, optical fiber cables including optical fibers coated from such compositions, and methods of producing coated optical fibers from such compositions.

### CROSS REFERENCE TO RELATED APPLICATIONS

This application claims priority to U.S. provisional patent application No. 62/774,576, filed 3 Dec. 2018, the entire content of which is hereby incorporated by reference in its entirety as if fully set forth herein.

### TECHNICAL FIELD

The present invention relates generally to methods of coating optical fibers, the filled radiation curable coatings suitable for use on optical fibers that are manufactured using high-speed, low-helium, and/or high temperature drawing, and the optical fibers produced therefrom.

### BACKGROUND

Optical fibers have been used in a variety of applications and have several advantages over other media. For example, data can be transmitted over optical fibers at a higher data rate than over wires. Optical fibers are also lighter and more flexible than wires. Thus, optical fibers, especially those made from glass, are often used in the telecommunication industry for data transmission. However, if left unprotected, optical fibers are unsuitable for field use because of the fragility of the thin glass strand across which optical signals are transmitted. In addition to their susceptibility to physical damage, uncoated optical fibers would also be negatively impacted by moisture contact. As a result, surface coatings have long-since been applied to optical fibers for protection and to ensure a high-level of performance.

It is well known to draw glass fibers from a specially prepared, cylindrical preform which has been locally and symmetrically heated to a temperature of, e.g., about 2000° C. As the preform is heated, such as by feeding the preform into and through a furnace, a glass fiber is drawn from the molten material. The surface coating compositions are applied to the glass fiber after it has been drawn from the preform, preferably immediately after cooling. The coating compositions are then cured to produce the coated optical fiber. General methods of applying dual layers of coating compositions to a moving glass fiber are well-known in the art, and are disclosed in U.S. Pat. No. 4,474,830 to Taylor and U.S. Pat. No. 4,851,165 to Rennell et al. Newer fiber design concepts can be found in U.S. Pat. No. 8,837,892, US 2014/0294355, and US 2015/0071595.

To protect them, optical fibers are frequently coated with two or more superposed radiation-curable coatings immediately after the fiber is produced by drawing. The coating which directly contacts the optical fiber is called the “inner primary coating” and an overlaying coating is called the “outer primary coating.” In some references, the inner primary coating is also called simply the “primary coating” and the outer primary coating is called a “secondary coating.” Inner primary coatings are typically formulated to possess a significantly lower modulus than secondary coatings.

The relatively soft inner primary coating provides resistance to microbending which results in added attenuation of the signal transmission (i.e. signal loss) of the coated optical fiber and is therefore undesirable. Microbends are microscopic curvatures in the optical fiber involving local axial displacements of a few micrometers and spatial wavelengths of a few millimeters. Microbends can be induced by thermal stresses and/or mechanical lateral forces. Coatings can provide lateral force protection that protect the optical fiber from microbending, but as coating thickness decreases the amount of protection provided decreases. The relationship between coatings and protection from lateral stress that leads to microbending is discussed, for example, in D. Gloge, “Optical-fiber packaging and its influence on fiber straightness and loss”, Bell System Technical Journal, Vol. 54, 2, 245 (1975); W. B. Gardner, “Microbending Loss in Optical Fibers”, Bell System Technical Journal, Vol. 54, No. 2, p. 457 (1975); J. Baldauf, “Relationship of Mechanical Characteristics of Dual Coated Single Mode Optical Fibers and Microbending Loss”, IEICE Trans. Commun., Vol. E76-B, No. 4, 352 (1993); and K. Kobayashi, “Study of Microbending Loss in Thin Coated Fibers and Fiber Ribbons”, IWCS, 386 (1993). The harder outer Primary coating, that is, the secondary coating, provides resistance to handling forces such as those encountered when the coated fiber is ribboned and/or cabled.

Optical fiber secondary coating compositions generally comprise, before cure, a mixture of ethylenically-unsaturated compounds, often consisting of one or more oligomers dissolved or dispersed in liquid ethylenically-unsaturated diluents and photoinitiators. The coating composition is typically applied to the optical fiber in liquid form and then exposed to actinic radiation to effect cure.

Primary coatings preferably possess a higher refractive index than the cladding of the associated optical fiber, in order to allow them to strip errant optical signals away from the core of the optical fiber. Primary coatings often are the cured product of a mixture of ethylenically-unsaturated compounds, including large quantities of typically urethane acrylate oligomers and reactive diluent monomers. Although additives such as glass adhesion promoters are used, primary coatings typically do not employ the use of organic fillers such as silica, as such materials would be expected to contribute to abrasions or cracks in the optical fiber cladding layer.

The primary coating typically has a thickness that is less than about 40 μm, although other thicknesses may be utilized. The primary coating is typically applied to the glass fiber and subsequently cured. Various additives that enhance one or more properties of the primary coating can also be present, including antioxidants, adhesion promoters, inhibitors, photosensitizers, carrier surfactants, tackifiers, catalysts, stabilizers, surface agents, and optical brighteners.

Secondary coatings are the outer coatings. The secondary coating is, for example, the polymerization product of a coating composition whose molecules become highly crosslinked when polymerized. The secondary coating typically has a high in situ modulus (e.g., greater than about 800 MPa at 25° C., more preferably from between about 1 GPa to about 3 GPa) and a high T_{g} (e.g., greater than about 50° C.). The in situ secondary modulus is preferably greater than about 1000 MPa. Secondary coatings often possess a thickness that is less than about 40 μm.

Fiber optic coatings, including the primary and secondary layers, typically are applied using one of two processes: wet-on-wet (WOW) and wet-on-dry (WOD). In the WOD process, the fiber passes first through a primary coating application, which is cured via exposure to ultraviolet (UV) radiation. The fiber then passes through a secondary coating application, which is subsequently cured by similar means. In the WOW process, the fiber passes through both the primary and secondary coating applications, whereupon the fiber proceeds to the curing step. In a wet-on-wet process, the curing lamps between primary and secondary coating application are omitted.

Radiant light energy is used in the manufacture of radiation curable coatings for optical fibers. In particular, curing processes use radiant energy from UV lamps to cure optical fiber coatings. UV lamps with broadband mercury spectra are commonly used in the industry, due to their high intensity and broad emission spectrum to ensure rapid and full cure of such radiation curable coatings. Increasingly, curing systems utilizing UV-LED (light emitting diodes) lamps have begun to be used as well, as their efficient construction enables a fiber production process with a reduced energy input.

The global demand for optical fiber continues to increase year-on-year. In order to meet this increasing demand, and also to provide a productivity advantage in such a competitive industry, it would be beneficial to increase, among other things, the speed at which an optical fiber is formed, coated, and cured. Current coating and process technology has enabled most fiber producers to operate draw towers comfortably at line speeds of at least 1000 m/min, with speeds of up to 1500 m/min and even 2500 m/min and higher also possible.

However, as the fiber draw speed increases, several technical challenges are introduced into the process, thereby increasing the difficulty by which a suitably coated optical fiber may be produced. Among these technical challenges include a reduction in the ability of the UV light source to impart sufficient doses of radiation to fully cure the primary and secondary coating compositions due to the reduced relative curing exposure time. Further challenges include an increased tendency for runout or concentricity errors in the application of the coated fiber, as vibrations characterized by higher line speeds could induce physical movement beyond the precise coating application tolerances. Yet additional challenges include bubble entrapment, coating delamination, and increased microbend-induced attenuation.

Many of these challenges are induced or exacerbated by an unwanted temperature differential between the freshly drawn glass fiber and the primary coating composition with which it comes into contact. At higher draw speeds, the fiber enters the primary coating die at a temperature that can significantly exceed 50° C. All else being equal, as fiber draw speeds increase, the previously molten glass fiber has less time to equilibrate to the ambient temperature at which the primary coating composition is applied. An insufficiently cooled glass fiber will induce a concomitant temperature increase in the primary coating during application, which may persist to the downstream curing step. The coating compositions (especially primary coating compositions) which are not sufficiently thermally resistive will be adversely affected by this phenomenon, therefore leading to a deterioration in the physical properties—and even the commercial viability—of the coated optical fiber produced therefrom.

A method for attempting to alleviate this problem is well-known in the industry. Such method involves increasing the rate at which a freshly drawn glass fiber may be cooled via the application of fluids with a higher heat transfer coefficient than ambient air, such as nitrogen or helium. Helium is known to be effective as it has a particularly high heat transfer coefficient. However, the amount of helium required for cooling glass fibers increases exponentially with increasing draw speed, such that there exist physical limitations to the amount which can be applied in a finite cooling tube space for a defined period of time. Furthermore, the high cost of helium makes it an expensive input during the fiber production process. An exponentially increasing requirement for such a costly variable would quickly offset the value of any productivity gains realized by the increased throughput achieved by a higher line speed. Thus, additional solutions are needed.

Further attempts to alleviate these problems via process optimization, construction of taller draw towers, more efficient helium application, and fiber drawing enhancements are known. However, in order to truly and more cost-effectively enable the use of optical fiber coating processes at even higher speeds, such as 3000 m/min or more, or at existing speeds with a reduction (or elimination) in the quantity of expensive helium required, it is necessary to improve the performance of the radiation curable coating compositions themselves. Further, it is believed that although changes to the oligomer and monomer chemistry can contribute to solving this problem, it would be desirable to incorporate additives into the primary coating composition which would enable even further improvements.

Specifically, an unmet need exists to provide optical fiber coatings, especially primary coatings, which exhibit superior processability at higher temperatures. Such higher temperatures may be introduced primarily via faster line processing speeds, reduced helium input, or both. Further, an unmet need exists to provide optical fiber coatings which are both sufficiently thermally resistive, and simultaneously are also being able to maintain or exceed existing coating performance levels the industry has come to expect. Such an improved primary coating may, in addition to being processable at higher line speeds or with lower helium input, also need to be fast curing, exhibit sufficient glass adhesion, and contribute to excellent microbend resistance by possessing a low modulus.

### BRIEF DESCRIPTION OF THE DRAWINGS

FIG. 1 is a cross-sectional view of an optical fiber according to embodiments described herein.

### BRIEF SUMMARY

Described herein are various embodiments of the invention, which include radiation curable compositions for coating an optical fiber, including primary coating compositions, secondary coating compositions, and matrix compositions, which include a filler component, and which exhibit improved thermal resistivity. Such thermal resistivity is measured by a ratio of the steady-state viscosity of the composition (at a shear rate of 10s⁻¹) at 25° C. to 85° C., or alternatively from 25° C. to 55° C. Also described are methods of coating such compositions onto an optical fiber, along with the coated optical fibers produced therefrom.

### DETAILED DESCRIPTION

A first embodiment of the current invention is a coated optical fiber, including an optical fiber portion, the optical fiber portion itself further including a glass core and a cladding layer in contact with and surrounding said glass core; and a coating portion, said coating portion further including a primary coating layer in contact with and surrounding said cladding layer; and a secondary coating layer in contact with and surrounding said primary coating layer. According to this first aspect, either the primary coating layer or the secondary coating layer is a cured product of a radiation curable composition comprising a reactive oligomer comprising at least one polymerizable group and a backbone; a reactive diluent monomer; a photoinitiator; a filler component; and optionally, one or more additives; wherein the radiation curable composition possesses a liquid glass transition temperature (Tg,rheo), a first viscosity at 25° Celsius (C) (η₂₅), a second viscosity at 55° C. (η₅₅), and a third viscosity at 85° C. (η₈₅); wherein, the ratio of the first viscosity to the third viscosity is less than 15, or less than 10, or less than 9, or less than 8, or less than 7, or less than 6, or less than 5, and greater than 2.5, or greater than 2.7, or greater than 2.8, or greater than 3, or greater than 4, or from 2.6 to 10, or form 2.6 to 9, or from 2.6 to 8, or from 2.6 to 7.

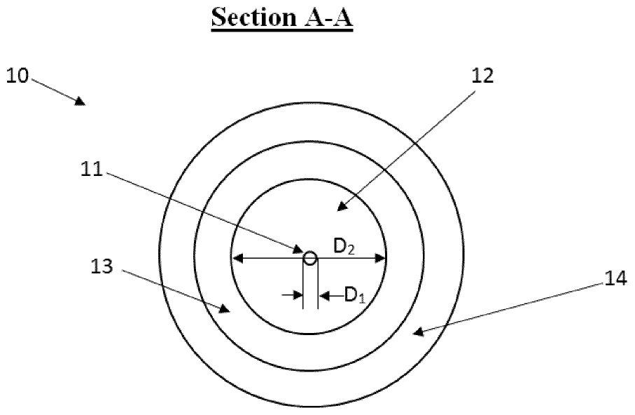

FIG. 1 is a cross-sectional view of an optical fiber 10, which is an example of the result of the coated fiber described herein.

The optical fiber 10 comprises a core 11, a cladding 12, a primary coating 13 contacting and surrounding the outer annular cladding region, and a secondary coating 14. The outer diameter of the core 11 is D₁ and the outer diameter of the cladding 12 is D₂. The primary coating 13 is a typical primary coating that has an in situ (or on-fiber) tensile modulus of less than 1.5 MPa, or less than 1.2 MPa, or as low as 0.35 MPa, 0.3 MPa, or 0.25 MPa, and in other embodiments not more than 0.2 MPa. Methods for describing in-situ modulus are well-known in the art and are described in, inter alia, U.S. Pat. Nos. 7,171,103 and 6,961,508, each of which is assigned to DSM IP Assets B.V. The cured primary coating 13 has an in-situ glass transition temperature less than −35° C., or less than −40° C., or less than −45° C., and in other embodiments not more than −50° C. A primary coating with a low in situ modulus reduces the microbending which is the coupling mechanism between the modes propagating in the fiber. A low in situ glass transition temperature ensures that the in-situ modulus of the primary coating will remain low even when the fiber is deployed in very cold environments. The microbending performance will therefore be stable with temperature, resulting in low mode coupling in all situations. The secondary coating 14 is in contact with and surrounds the primary coating 13. The secondary coating 14 has an in situ tensile modulus of greater than 800 MPa, or greater than 1110 MPa, or greater than 1300 MPa, or greater than 1400 MPa, or greater than 1500 MPa. A secondary coating with a high in situ modulus reduces the microbending which is the coupling mechanism between the modes propagating in the fiber.

In the embodiments shown and described herein, core 11 comprises pure silica glass (SiO₂) or silica glass with one or more dopants that increase the index of refraction of the glass core relative to pure, undoped silica glass. Suitable dopants for increasing the index of refraction of the core include, without limitation, GeO₂, Al₂O₃, P₂O₅, TiO₂, ZrO₂, Nb₂O₅, Ta₂O₅, and/or combinations thereof. The cladding 12 may comprise pure silica glass (SiO₂), silica glass with one or more dopants which increase the index of refraction (e.g., GeO₂, Al₂O₃, P₂O₅, TiO₂, ZrO₂, Nb₂O₅ and/or Ta₂O₅), such as when the cladding is “up-doped,” or silica glass with a dopant which decreases the index of refraction, such as fluorine, such as when the inner cladding is “down-doped”, so long as the maximum relative refractive index [Δ_{1MAX}] of the core 11 is greater than the maximum relative refractive index [Δ_{4MAX}] of the cladding 12. According to one embodiment, cladding 12 is pure silica glass.

Any optical fiber type may be used in embodiments of the present invention. In a preferred embodiment, however, the coated optical fiber possesses a mode-field diameter from 8 to 10 μm at a wavelength of 1310 nm, or a mode-field diameter from 9 to 13 μm at a wavelength of 1550 nm, and/or an effective area between 20 and 200 μm². Such fibers may be single mode and/or large-effective area fibers, given the expected demand for coating processes for these fibers that utilize higher line or processing speeds. However, other fiber types, such as multimode fibers, may be used as well.

The primary coating 13 preferably has a higher refractive index than the cladding 12 of the optical fiber 10, in order to allow it to strip errant optical signals away from the core of optical fiber. For example, an exemplary transmission optical fiber 10 may have refractive index values at a wavelength of 1550 nm for the core and cladding of 1.447 and 1.436, respectively; as such, it is desirable that the refractive index of primary coating 13 be greater than 1.44 at 1550 nm. The primary coating 13 maintains adequate adhesion to the glass fiber during thermal and hydrolytic aging, yet (if needed) is capable of being strippable therefrom for splicing purposes. The primary coating 13 typically has a thickness in the range of 20-50 μm (e.g., about 25 or 32.5 μm), thinner thickness in the range of 15-25 μm for 200 μm fibers.

Coating 13 is a primary coating, which normally is applied directly to the glass fiber. Coating 13 is preferably formed from a soft crosslinked polymer material having a low in situ modulus and a low in situ T_{g}

The primary coating 13 preferably has a thickness that is less than about 40 μm, more preferably between about 20 to about 40 μm, most preferably between about 20 to about 30 μm. Primary coating 13 is typically applied to the glass fiber and subsequently cured, as will be described in more detail herein below. Various additives that enhance one or more properties of the primary coating can also be present, including antioxidants, adhesion promoters, PAG compounds, photosensitizers, carrier surfactants, tackifiers, catalysts, stabilizers, surface agents, and optical brighteners of the types described above.

In an embodiment, suitable primary coating compositions may include, without limitation, about 10 to 95 weight percent, or from 10 to 90 weight percent, or from about 25 to about 75 weight percent of one or more urethane acrylate oligomers; about 10 to about 65 weight percent, more preferably from about 25 to about 65 weight percent of one or more monofunctional ethylenically unsaturated monomers; about 0 to about 10 weight percent of one or more multifunctional ethylenically unsaturated monomers; about 1 to about 5 weight percent of one or more photoinitiators; about 0.5 to about 1.5 pph of one or more antioxidants; optionally about 0.5 to about 1.5 pph of one or more adhesion promoters; optionally about 0.1 to about 10 pph PAG compound; and about 0.01 to about 0.5 pph of one or more stabilizers.

Coating 14 is the outer coating, and it serves the traditional purpose of a “secondary coating”. The outer coating material 14 is, for example, the polymerization product of a coating composition whose molecules become highly crosslinked when polymerized. In the embodiments described herein coating 14 has a high in situ modulus (e.g., greater than about 800 MPa at 25° C.) and a high T_{g} (e.g., greater than about 50° C.). The in situ secondary modulus is preferably greater than about 1000 MPa, more preferably greater than about 1100 MPa and most preferably greater than about 1200 MPa. According to some preferred embodiments, the in situ secondary modulus is greater than 1200 MPa. In other preferred embodiments, the in situ secondary modulus is between about 1000 MPa and about 8000 MPa, more preferably between about 1200 MPa and about 5000 MPa, and most preferably between about 1500 MPa and about 3000 MPa. The in situ T_{g} of the secondary coating is preferably between about 50° C. and about 120° C., more preferably between about 50° C. and about 100° C. In an embodiment, the secondary coating 14 has a thickness that is less than about 40 μm, more preferably between about 20 to about 40 μm, most preferably between about 20 to about 30 μm.

Other suitable materials for use in outer (or secondary) coating materials, as well as considerations related to selection of these materials, are well known in the art and are described in, for example, U.S. Pat. Nos. 4,962,992 and 5,104,433 to Chapin. As an alternative to these, high modulus coatings have also been obtained using low oligomer content coating systems, as described in U.S. Pat. No. 6,775,451 to Botelho et al., and U.S. Pat. No. 6,689,463 to Chou et al. In addition, non-reactive oligomer components have been used to achieve high modulus coatings, as described in U.S. Application Publ. No. 20070100039 to Schissel et al. Outer coatings are typically applied to the previously coated fiber (either with or without prior curing) and subsequently cured, as will be described in more detail herein below. Various additives that enhance one or more properties of the coating can also be present, including antioxidants, PAG compounds, photosensitizers, catalysts, lubricants, low molecular weight non-crosslinking resins, stabilizers, surfactants, surface agents, slip additives, waxes, micronized-polytetrafluoroethylene, etc. The secondary coating may also include an ink, as is well known in the art.

Suitable compositions for the secondary or outer coating 14 include, without limitation, about 0 to 70 weight percent of one or more urethane acrylate oligomers; about 20 to about 95 weight percent of one or more multifunctional ethylenically unsaturated monomers; about 0 to about 10 weight percent of one or more monofunctional ethylenically unsaturated monomers; about 1 to about 5 weight percent of one or more photoinitiators; about 0 to about 5 pph of one or more slip additives; and about 0.5 to about 1.5 pph of one or more antioxidants.

It is known in the art how to formulate typical optical fiber coating for primary and secondary coatings for fiber as described above, as well as for ink and matrix materials for curing using broadband UV lamps. A good discussion of this technology and associated chemistry and test methods can be found in sections 4.6 to the end of chapter 4 in the textbook, “Specialty Optical Fibers Handbook” by A. Mendez and T. F. Morse, © Elsevier Inc. 2007, published by Elsevier.

A second aspect is a radiation curable composition for coating an optical fiber comprising: a reactive oligomer comprising at least one polymerizable group and a backbone; a reactive diluent monomer; a photoinitiator; a filler component; and optionally, one or more additives; wherein the radiation curable composition possesses a liquid glass transition temperature (Tg,rheo), a first viscosity at 25° Celsius (C) (η₂₅), a second viscosity at 55° C. (η₅₅), and a third viscosity at 85° C. (η₈₅); wherein, the ratio of the first viscosity to the third viscosity is less than 15, or less than 10, or less than 9, or less than 8, or less than 7, or less than 6, or less than 5, and greater than 2.5, or greater than 2.7, or greater than 2.8, or greater than 3, or greater than 4, or from 2.6 to 10, or form 2.6 to 9, or from 2.6 to 8, or from 2.6 to 7.

Radiation curable primary compositions for coating optical fibers according to the second aspect of the present invention contain at least two ethylenically unsaturated polymerizable compounds, including at least one reactive diluent monomer and a radiation curable oligomer, as well as one or more photoinitiators, a filler component, and an optional additive package. Such components described below may be used in radiation curable compositions according to any of the aspects of the present invention, including coatings used in the optical fibers according to the first aspect, the compositions of the second aspect, and the like.

### Ethylenically Unsaturated Polymerizable Compounds

The ethylenically unsaturated polymerizable compounds can contain one or more than one reactive olefinic double bond. They may be low molecular weight (monomeric) or high molecular weight (oligomeric) compounds.

### Reactive Diluent Monomers

Typical examples of lower molecular weight monomers containing one double bond are alkyl or hydroxyalkyl acrylates or methacrylates, for example methyl, ethyl, butyl, 2-phenoxy ethyl, 2-ethylhexyl, and 2-hydroxyethyl acrylate, isobornyl acrylate, methyl and ethyl methacrylate, lauryl-acrylate, ethoxylated nonyl-phenol acrylate, and diethylene-glycol-ethyl-hexyl acylate (DEGEHA). Further examples of these monomers are acrylonitrile, acrylamide, methacrylamide, N-substituted (meth)acrylamides, vinyl esters such as vinyl acetate, styrene, alkylstyrenes, halostyrenes, N-vinylpyrrolidone, N-vinyl caprolactam, vinyl chloride and vinylidene chloride. Examples of monomers containing more than one double bond are ethylene glycol diacrylate, propylene glycol diacrylate, tripropylene glycol diacrylate, neopentyl glycol diacrylate, hexamethylene glycol diacrylate, bisphenol A diacrylate, 4,4′-bis(2-acryloyloxyethoxy)diphenylpropane, trimethylolpropane triacrylate, pentaerythritol triacrylate and tetraacrylate, vinyl acrylate, divinyl benzene, divinyl succinate, diallyl phthalate, triallyl phosphate, triallyl isocyanurate or tris(2-acryloylethyl)isocyanurate.

The monomer used may be apolar or polar. Certain apolar monomers which may be suitably used include 2-ethylhexyl acrylate (EHA), isodecyl acrylate (IDA), lauryl acrylate (LA), isobornyl acrylate (IBOA), and various caprolactone acrylates, such as those known commercially as Tone™ M100 or Sartomer SR 495B.

Particularly preferred are polar monomers, including dimethylacryl-amide (dMAA), n-vinyl pyrrolidone (nVP), 2-(2-ethoxyethoxy)ethyl acrylate (EOEOA), 4-hydroxy butyl acrylate (4-HBA), 2-phenoxyethyl acrylate (PEA), and ethoxylated 2-phenoxy ethyl acrylate (EPEA). Inventors have surprisingly discovered that, relative to apolar monomers, more polar monomers of a similar viscosity tend to more effectively contribute to a lower liquid glass transition temperature of the composition with which they are associated. As is discussed elsewhere herein, infra, this combination of characteristics may be valuable to contributing to the formulation of a radiation curable composition which exhibits certain advantages of the current invention.

One or more of the aforementioned reactive diluent monomers can be employed in compositions according to the present invention in any suitable amount and may be chosen singly or in combination of one or more of the types enumerated herein. In a preferred embodiment, the reactive diluent monomer component is present in an amount, relative to the entire weight of the composition, of from about 5 wt. % to about 90 wt. %, or from about 10 wt. % to about 90 wt. %, or from about 10 wt. % to about 80 wt. %., or from about 10 wt. % to about 60 wt. %.

### Oligomers

Generally, optical fiber coating materials comprise as a reactive oligomer component. An oligomer is a molecule of intermediate relative molecular mass, the structure of which comprises a plurality of units derived, actually or conceptually, from molecules of lower relative molecular mass. As used herein, an “oligomer” possesses a number average molecular weight (Mn) from about 600 g/mol to about 25,000 g/mol, as measured by size exclusion chromatography (SEC) calibrated with a polystyrene standard in tetrahydrofuran.

Such components typically include a urethane acrylate oligomer comprising an acrylate group, urethane groups and a backbone. The backbone is derived from a polyol which has been reacted with an isocyanate, such as a diisocyanate, a polyisocyanate, and a hydroxyalkylacrylate.

Examples of suitable polyols are polyether polyols, polyester polyols, polycarbonate polyols, polycaprolactone polyols, acrylic polyols, and other polyols. These polyols may be used either individually or in combinations of two or more. In a preferred embodiment, the backbone of the urethane acrylate oligomer comprises a compound derived from a polypropylene glycol (PPG). As used herein, a compound derived from a polypropylene glycol includes an endcapped PPG, such as an EO-endcapped PPG. There are no specific limitations to the manner of polymerization of the structural units in these polyols. Each of random polymerization, block polymerization, or graft polymerization is acceptable.

As used herein, a block copolymer means a portion of an oligomer or polymer, comprising many constitutional units, wherein at least one constitutional unit comprises a feature that is not present in adjacent portions. As used herein, mono-, di-, and tri-block copolymers refer to the average amount of a particular block present in the oligomer. In a preferred embodiment, the particular block refers to a polyether block, which is derived from one or more of the polyols, preferably polyether polyols, described elsewhere herein. In an embodiment, the block to which a mono-, di-, and/or tri-block copolymer refers is a polyether block which is derived from one or more of the polyols described elsewhere herein. In an embodiment, a monoblock copolymer may be described as a copolymer having only an average of around 1, or from about 0.9 to less than 1.5 units of a particular block, such as a polyether block. In an embodiment, a diblock copolymer may be described as a copolymer having an average of around 2, or from at least 1.5 to less than 2.5 units of a particular block, such as a polyether block. In an embodiment, a triblock copolymer may be described as a copolymer having an average of around 3, or from at least 2.5 to less than 3.5 units of a particular block, such as a polyether block. The number of polyether units in a given oligomer may be determined by the number of polyether polyol molecules utilized in the synthesis of a single oligomer.

Given as examples of the polyether polyols are polyethylene glycol, polypropylene glycol, polypropylene glycol-ethyleneglycol copolymer, polytetramethylene glycol, polyhexamethylene glycol, polyheptamethylene glycol, polydecamethylene glycol, and polyether diols obtained by ring-opening copolymerization of two or more ion-polymerizable cyclic compounds. Here, given as examples of the ion-polymerizable cyclic compounds are cyclic ethers such as ethylene oxide, isobutene oxide, tetrahydrofuran, 2-methyltetrahydrofuran, 3-methyltetrahydrofuran, dioxane, trioxane, tetraoxane, cyclohexene oxide, styrene oxide, epichlorohydrin, isoprene monoxide, vinyl oxetane, vinyl tetrahydrofuran, vinyl cyclohexene oxide, phenyl glycidyl ether, butyl glycidyl ether, and glycidyl benzoate. Specific examples of combinations of two or more ion-polymerizable cyclic compounds include combinations for producing a binary copolymer such as tetrahydrofuran and 2-methyltetrahydrofuran, tetrahydrofuran and 3-methyltetrahydrofuran, and tetrahydrofuran and ethylene oxide; and combinations for producing a ternary copolymer such as a combination of tetrahydrofuran, 2-methyltetrahydrofuran, and ethylene oxide, a combination of tetrahydrofuran, butene-1-oxide, and ethylene oxide, and the like. The ring-opening copolymers of these ion-polymerizable cyclic compounds may be either random copolymers or block copolymers.

Included in these polyether polyols are products commercially available under the trademarks, for example, PTMG1000, PTMG2000 (manufactured by Mitsubishi Chemical Corp.), PEG #1000 (manufactured by Nippon Oil and Fats Co., Ltd.), PTG650 (SN), PTG1000 (SN), PTG2000 (SN), PTG3000, PTGL1000, PTGL2000 (manufactured by Hodogaya Chemical Co., Ltd.), PEG400, PEG600, PEG1000, PEG1500, PEG2000, PEG4000, PEG6000 (manufactured by Daiichi Kogyo Seiyaku Co., Ltd.) and Pluronics (by BASF).

Polyester diols obtained by reacting a polyhydric alcohol and a polybasic acid are given as examples of the polyester polyols. As examples of the polyhydric alcohol, ethylene glycol, polyethylene glycol, tetramethylene glycol, polytetramethylene glycol, 1,6-hexanediol, 3-methyl-1,5-pentanediol, 1,9-nonanediol, 2-methyl-1,8-octanediol, and the like can be given. As examples of the polybasic acid, phthalic acid, dimer acid, isophthalic acid, terephthalic acid, maleic acid, fumaric acid, adipic acid, sebasic acid, and the like can be given.

These polyester polyol compounds are commercially available under the trademarks such as MPD/IPA500, MPD/IPA1000, MPD/IPA2000, MPD/TPA500, MPD/TPA1000, MPD/TPA2000, Kurapol A-1010, A-2010, PNA-2000, PNOA-1010, and PNOA-2010 (manufactured by Kuraray Co., Ltd.).

As examples of the polycarbonate polyols, polycarbonate of polytetrahydrofuran, poly(hexanediol carbonate), poly(nonanediol carbonate), poly(3-methyl-1,5-pentamethylene carbonate), and the like can be given.

As commercially available products of these polycarbonate polyols, DN-980, DN-981 (manufactured by Nippon Polyurethane Industry Co., Ltd.), Priplast 3196, 3190, 2033 (manufactured by Unichema), PNOC-2000, PNOC-1000 (manufactured by Kuraray Co., Ltd.), PLACCEL CD220, CD210, CD208, CD205 (manufactured by Daicel Chemical Industries, Ltd.), PC-THF-CD (manufactured by BASF), and the like can be given.

Polycaprolactone diols obtained by reacting e-caprolactone and a diol compound are given as examples of the polycaprolactone polyols having a melting point of 0° C. or higher. Here, given as examples of the diol compound are ethylene glycol, polyethylene glycol, polypropylene glycol, tetramethylene glycol, polytetramethylene glycol, 1,2-polybutylene glycol, 1,6-hexanediol, neopentyl glycol, 1,4-cyclohexanedimethanol, 1,4-butanediol, and the like.

Commercially available products of these polycaprolactone polyols include PLACCEL 240, 230, 230ST, 220, 220ST, 220NP1, 212, 210, 220N, 210N, L230AL, L220AL, L220PL, L220PM, L212AL (all manufactured by Daicel Chemical Industries, Ltd.), Rauccarb 107 (by Enichem), and the like.

As examples of other polyols ethylene glycol, 1,4-butanediol, 1,5-pentanediol, 1,6-hexanediol, polyoxyethylene bisphenol A ether, polyoxypropylene bisphenol A ether, polyoxyethylene bisphenol F ether, polyoxypropylene bisphenol F ether, and the like can be given.

As these other polyols, those having a alkylene oxide structure in the molecule, in particular polyether polyols, are preferred. In an embodiment, polyols containing polytetramethylene glycol and copolymer glycols of butyleneoxide and ethyleneoxide are particularly preferred.

The number average molecular weight derived from the hydroxyl number of these polyols is usually from about 50 to about 15,000, and preferably from about 1,000 to about 8,000. As used herein, unless otherwise specified, molecular weight refers to a number average molecular weight, as specified in grams/mol (g/mol), as determined by SEC calibrated with a polystyrene standard.

Given as examples of the polyisocyanate used for the oligomer are 2,4-tolylene diisocyanate, 2,6-tolylene diisocyanate, 1,3-xylylene diisocyanate, 1,4-xylylene diisocyanate, 1,5-naphthalene diisocyanate, m-phenylene diisocyanate, p-phenylene diisocyanate, 3,3′-dimethyl-4,4′-diphenylmethane diisocyanate, 4,4′-diphenylmethane diisocyanate, 3,3′-dimethylphenylene diisocyanate, 4,4′-biphenylene diisocyanate, 1,6-hexane diisocyanate, isophorone diisocyanate, methylenebis(4-cyclohexylisocyanate), 2,2,4-trimethylhexamethylene diisocyanate, 2,4,4 trimethylhexamethylene diisocyanate, hexamethylene diisocyanate, bis(2-isocyanato-ethyl)fumarate, 6-isopropyl-1,3-phenyl diisocyanate, 4-diphenylpropane diisocyanate, hydrogenated diphenylmethane diisocyanate, hydrogenated xylylene diisocyanate, tetramethyl xylylene diisocyanate, lysine isocyanate, and the like. These polyisocyanate compounds may be used either individually or in combinations of two or more. Preferred polyisocyanates are isophorone diisocyanate, 2,2,4-trimethylhexamethylene diisocyanate, 2,4,4 trimethylhexamethylene diisocyanate and hexamethylene diisocyanate, 2,4-tolylene diisocyanate, and 2,6-tolylene diisocyanate.

Examples of the hydroxyl group-containing (meth)acrylate used in the oligomer, include, (meth)acrylates derived from (meth)acrylic acid and epoxy and (meth)acrylates comprising alkylene oxides, more in particular, 2-hydroxy ethyl (meth)acrylate, 2-hydroxypropylacrylate, 2-hydroxy-3-oxyphenyl(meth)acrylate, and hydroxyethylcaprolactoneacrylate. Acrylate functional groups are preferred over methacrylates.

The ratio of polyol, polyisocyanate, and hydroxyl group-containing (meth)acrylate used for preparing the urethane (meth)acrylate is determined so that about 1.1 to about 3 equivalents of an isocyanate group included in the polyisocyanate and about 0.1 to about 1.5 equivalents of a hydroxyl group included in the hydroxyl group-containing (meth)acrylate are used for one equivalent of the hydroxyl group included in the glycol.

In the reaction of these three components, a urethanization catalyst such as copper naphthenate, cobalt naphthenate, zinc naphthenate, di-n-butyl tin dilaurate, triethylamine, and triethylenediamine-2-methyltriethyleneamine, is usually used in an amount from about 0.01 to about 1 wt. % of the total amount of the reactant. The reaction is carried out at a temperature from about 10 to about 90° C., and preferably from about 30 to about 80° C.

The number average molecular weight (Mn) of the urethane (meth)acrylate used in the composition of the present invention is preferably in the range from about 600 to about 25,000, and more preferably from about 2,200 to about 10,000, as measured by as measured by size exclusion chromatography (SEC) calibrated with a polystyrene standard in tetrahydrofuran. If the Mn of the urethane (meth)acrylate is less than about 100, the resin composition tends to solidify; on the other hand, if the Mn becomes larger than about 25,000, the viscosity of the composition becomes high, making handling of the composition difficult. In an embodiment, the Mn of the inner primary coating oligomer is between about 2,200 and about 5,500.

Other oligomers that can be used include polyester (meth)acrylate, epoxy (meth)acrylate, polyamide (meth)acrylate, siloxane polymer having a (meth)acryloyloxy group, a reactive polymer obtained by reacting (meth)acrylic acid and a copolymer of glycidyl methacrylate and other polymerizable monomers, and the like. Particularly preferred are bisphenol A based acrylate oligomers such as alkoxylated bisphenol-A-diacrylate and diglycidyl-bisphenol-A-diacrylate.

Beside the above-described components, other curable oligomers or polymers may be added to the liquid curable resin composition of the present invention to the extent that the characteristics of the liquid curable resin composition are not adversely affected.

Preferred oligomers are polyether-based acrylate oligomers, polycarbonate acrylate oligomers, polyester acrylate oligomers, alkyd acrylate oligomers and acrylated acrylic oligomers. More preferred are the urethane-containing oligomers thereof. Even more preferred are polyether urethane acrylate oligomers and urethane acrylate oligomers using blends of the above polyols, and particularly preferred are aliphatic polyether urethane acrylate oligomers. The term “aliphatic” refers to a wholly aliphatic polyisocyanate used.

However, also urethane-free acrylate oligomers, such as urethane-free acrylated acrylic oligomers, urethane-free polyester acrylate oligomers and urethane-free alkyd acrylate oligomers are also preferred. Examples of such high molecular weight (oligomeric) polyunsaturated compounds are acrylated epoxy resins, acrylated polyethers, and acrylated polyesters. Further examples of unsaturated oligomers are unsaturated polyester resins, which are usually prepared from maleic acid, phthalic acid and one or more diols and which have molecular weights of greater than about 500. Unsaturated oligomers of this type are also known as prepolymers. Typical examples of unsaturated compounds are esters of ethylenically unsaturated carboxylic acids and polyols or polyepoxides, and polymers containing ethylenically unsaturated groups in the chain or in side groups, including unsaturated polyesters, polyamides and copolymers thereof, polybutadiene and butadiene copolymers, polyisoprene and isoprene copolymers, polymers and copolymers containing (meth)acrylic groups in side-chains, as well as mixtures of one or more than one such polymer. Illustrative examples of unsaturated carboxylic acids are acrylic acid, methacrylic acid, crotonic acid, itaconic acid, cinnamic acid, unsaturated fatty acids such as linolenic acid or oleic acid. Suitable polyols are aromatic, aliphatic and cycloaliphatic polyols. Aromatic polyols are typically hydroquinone, 4,4′-dihydroxydiphenyl, 2,2-bis(4-hydroxyphenyl)propane, as well as novolacs and cresols. Polyepoxides include those based on the cited polyols, for instance on the aromatic polyols and epichlorohydrin.

Further suitable polyols are polymers and copolymers which contain hydroxyl groups in the polymer chain or in side groups, for example polyvinyl alcohol and copolymers thereof or hydroxyalkyl polymethacrylates or copolymers thereof. Other suitable polyols are oligoesters carrying hydroxyl end groups. Illustrative examples of aliphatic and cycloaliphatic polyols are alkylenediols containing for example 2 to 12 carbon atoms, including ethylene glycol, 1,2- or 1,3-propanediol, 1,2-, 1,3- or 1,4-butanediol, pentanediol, hexanediol, octanediol, dodecanediol, diethylene glycol, triethylene glycol, polyethylene glycols having molecular weights of for instance 200 to 1500, 1,3-cyclopentanediol, 1,2-, 1,3- or 1,4-cyclohexanediol, 1,4-dihydroxymethylcyclohexane, glycerol, tris(-hydroxyethyl)amine, trimethylolethane, trimethylolpropane, pentaerythritol, dipentaerythritol and sorbitol. The polyols may be esterified partially or completely with one or with different unsaturated carboxylic acids, in which case the free hydroxyl groups of the partial esters may be modified, for example etherified, or esterified with other carboxylic acids. Illustrative examples of esters are: trimethylolpropane triacrylate, trimethylolethane triacrylate, trimethylolpropane trimethacrylate, trimethylolethane trimethacrylate, tetramethylene glycol dimethacrylate, triethylene glycol dimethacrylate, tetraethylene glycol diacrylate, pentaerythritol diacrylate, pentaerythritol triacrylate, pentaerythritol tetraacrylate, dipentaerythritol diacrylate, dipentaerythritol triacrylate, dipentaerythritol tetraacrylate, dipentaerythritol pentacrylate, dipentaerythritol hexacrylate, tripentaerythritol octacrylate, pentaerythritol dimethacrylate, pentaerythritol trimethacrylate, dipentaerythritol dimethacrylate, dipentaerythritol tetramethacrylate, tripentaerythritol octamethacrylate, pentaerythritol diitaconate, dipentaerythritol trisitaconate, dipentaerythritol pentaitaconate, dipentaerythritol hexaitaconate, ethylene glycol diacrylate, 1,3-butanediol diacrylate, 1,3-butanediol dimethacrylate, 1,4-butanediol diitaconate, sorbitol triacrylate, sorbitol tetraacrylate, pentaerythritol-modified triacrylate, sorbitol tetramethacrylate, sorbitol pentacrylate, sorbitol hexacrylate, oligoester acrylates and methacrylates, glycerol di- and -triacrylate, 1,4-cyclohexanediacrylate, bisacrylates and bismethacrylates of polyethylene glycol having molecular weights of 200 to 1500, or mixtures thereof. Polyfunctional monomers and oligomers are available for example from UCB Chemicals of Smyrna, Ga., and Sartomer of Exton, Pa.

The reactive oligomer, which is an ethylenically unsaturated polymerizable oligomer preferably comprises, or consists, or consists essentially of urethane acrylate oligomers. The reactive oligomer possesses at least one polymerizable group, although in a preferred embodiment the reactive oligomer is difunctional; i.e., it possesses on average between 1.5 to 2.5 reactive groups per molecule.

One or more of the aforementioned ethylenically unsaturated oligomers can be employed in compositions according to the present invention in any suitable amount and may be chosen singly or in combination of one or more of the types enumerated herein. In an embodiment, the ethylenically unsaturated oligomer component is present in an amount, relative to the entire weight of the composition, of from about 5 wt. % to about 90 wt. %, or from about 10 wt. % to about 90 wt. %, or from about 10 wt. % to about 80 wt. %. In a preferred embodiment, however, a large quantity of the ethylenically unsaturated oligomer should be employed to obtain the desired first viscosity of the composition for a given configuration for high temperature resistance, such as, relative to the total weight of the composition, at least 50 wt. %, or at least 55 wt. %, or at least 60 wt. %, or at least 65 wt. %, or at least 70 wt. %, or from 45-85 wt. %, or from 55 to 80 wt. %, or from 60 to 85 wt. %, or from 60 to 80 wt. %.

### Free-Radical Photoinitiator Component

In preferred embodiments, the liquid radiation curable resin for coating an optical fiber of the present invention includes a free-radical photoinitiator component. The photoinitiator is a compound that chemically changes due to the action of light or the synergy between the action of light and the electronic excitation of a sensitizing dye to produce at least one of a radical, an acid, and a base.

According to an embodiment of the present invention, the free-radical photoinitiator is an acylphosphine oxide photoinitiator. Acylphosphine oxide photoinitiators are disclosed for example in U.S. Pat. Nos. 4,324,744, 4,737,593, 5,942,290, 5,534,559, 6,020,529, 6,486,228, and 6,486,226.

The acylphosphine oxide photoinitiators are bisacylphosphine oxides (BAPO) or monoacylphosphine oxides (MAPO).

The bisacylphosphine oxide photoinitiators are of the formula I:

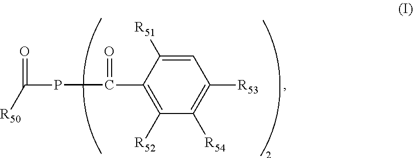

wherein R₅₀ is C₁-C₁₂ alkyl, cyclohexyl or phenyl which is unsubstituted or is substituted by 1 to 4 halogen or C₁-C₈ alkyl;
R₅₁ and R₅₂ are each independently of the other C₁-C₈ alkyl or C₁-C₈alkoxy;
R₅₃ is hydrogen or C₁-C₈ alkyl; and
R₅₄ is hydrogen or methyl.

For example, R₅₀ is C₂-C₁₀ alkyl, cyclohexyl or phenyl which is unsubstituted or is substituted by 1 to 4 C₁-C₄ alkyl, Cl or Br. Another embodiment is where R₅₀ is C₃-C₈ alkyl, cyclohexyl or phenyl which is unsubstituted or is substituted in the 2-, 3-, 4- or 2,5-positions by C₁-C₄ alkyl. For instance, R₅₀ is C₄-C₁₂ alkyl or cyclohexyl, R₅₁ and R₅₂ are each independently of the other C₁-C₈ alkyl or C₁-C₈alkoxy and R₅₃ is hydrogen or C₁-C₈ alkyl. For instance, R₅₁ and R₅₂ are C₁-C₄ alkyl or C₁-C₄alkoxy and R₅₃ is hydrogen or C₁-C₄ alkyl. Another embodiment is where R₅₁ and R₅₂ are methyl or methoxy and R₅₃ is hydrogen or methyl. For example, R₅₁, R₅₂ and R₅₃ are methyl. Another embodiment is where R₅₁, R₅₂ and R₅₃ are methyl and R₅₄ is hydrogen. Another embodiment is where R₅₀ is C₃-C₈ alkyl. For example, R₅₁ and R₅₂ are methoxy, R₅₃ and R₅₄ are hydrogen and R₅₀ is isooctyl. For instance, R₅₀ is isobutyl. For example, R₅₀ is phenyl. The present bisacylphosphine oxide photoinitiator is for example bis(2,4,6-trimethylbenzoyl)-phenylphosphine oxide (CAS #162881-26-7) or is bis(2,4,6-trimethylbenzoyl)-(2,4-bis-pentyloxyphenyl)phosphine oxide.

The monoacylphosphine oxide photoinitiators are of the formula II:

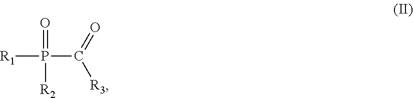

in which
R₁ and R₂ independently of one another are C₁-C₁₂alkyl, benzyl, phenyl which is unsubstituted or substituted from one to four times by halogen, C₁-C₈ alkyl and/or C₁-C₈ alkoxy, or are cyclohexyl or a group —COR₃, or
R₁ is —OR₄;
R₃ is phenyl which is unsubstituted or substituted from one to four times by C₁-C₈ alkyl, C₁-C₈ alkoxy, C₁-C₈ alkylthio and/or halogen; and
R₄ is C₁-C₈ alkyl, phenyl or benzyl. For example, R₁ is —OR₄. For example, R₂ is phenyl which is unsubstituted or substituted from one to four times by halogen, C₁-C₈ alkyl and/or C₁-C₈ alkoxy. For example, R₃ is phenyl which is unsubstituted or substituted from one to four times by C₁-C₈alkyl. For example, the present monoacylphosphine oxide is 2,4,6-trimethylbenzoylethoxyphenylphosphine oxide (CAS #84434-11-7) or 2,4,6-trimethylbenzoyldiphenylphosphine oxide (CAS #127090-72-6).

Compositions according to the present invention may also employ further photoinitiators, for example α-hydroxy ketone photoinitiators of the formula III:

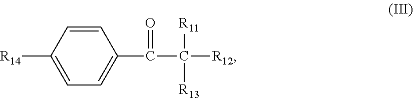

where
R₁₁ and R₁₂ independently of one another are hydrogen, C₁-C₆ alkyl, phenyl, C₁-C₆ alkoxy, OSiR₁₆(R₁₇)₂ or —O(CH₂CH₂O)_{q}—C₁-C₆ alkyl, or
R₁₁ and R₁₂, together with the carbon atom to which they are attached, form a cyclohexyl ring;
q is a number from 1 to 20;
R₁₃ is OH, C₁-C₁₆ alkoxy or —O(CH₂CH₂O)_{q}—C₁-C₆ alkyl;
R₁₄ is hydrogen, C₁-C₁₈ alkyl, C₁-C₁₂hydroxyalkyl, C₁-C₁₈ alkoxy, —OCH₂CH₂—OR₁₅, —CH═CH₂, —C(CH₃)═CH₂ or is

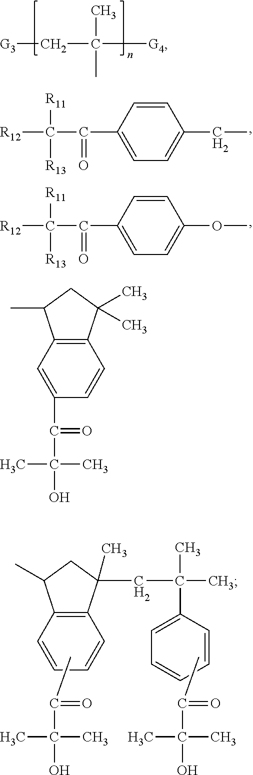

n is a number from 2 to 10;
R₁₅ is hydrogen, —COCH═CH₂ or —COC(CH₃)═CH₂;
R₁₆ and R₁₇ independently of one another are C₁-C₈ alkyl or phenyl; and
G₃ and G₄ independently of one another are end groups of the polymeric structure, preferably hydrogen or methyl.

α-hydroxy ketone photoinitiators that are of interest are those in which R₁₁ and R₁₂ independently of one another are hydrogen, C₁-C₆ alkyl or phenyl or R₁₁ and R₁₂, together with the carbon atom to which they are attached, form a cyclohexyl ring, R₁₃ is OH, and R₁₄ is hydrogen, C₁-C₁₂ alkyl, C₁-C₁₂ alkoxy, —OCH₂CH₂OR₁₅, —C(CH₃)═CH₂ or is

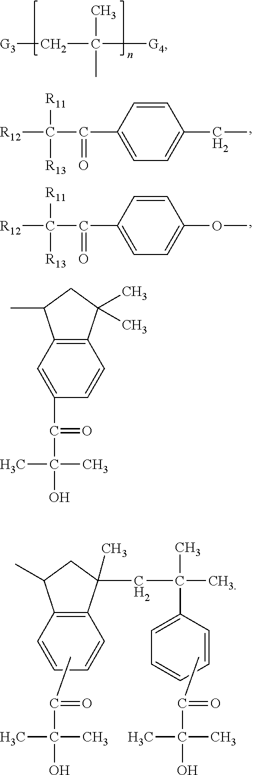

For example, suitable as the α-hydroxy ketone photoinitiators are those in which R₁₁ and R₁₂ independently of one another are methyl or ethyl or R₁₁ and R₁₂, together with the carbon atom to which they are attached, form a cyclohexyl ring, R₁₃ is hydrogen and R₁₄ is hydrogen, C₁-C₄alkyl, C₁-C₄ alkoxy or —OCH₂CH₂OH. Interesting also are compounds, wherein R₁₄ is

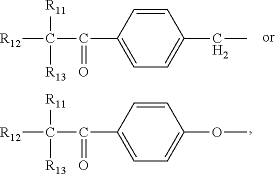

For instance, suitable α-hydroxy ketone photoinitiators are α-hydroxycyclohexyl phenyl ketone,
2-hydroxy-2-methyl-1-phenylpropanone,
2-hydroxy-2-methyl-1-(4-isopropylphenyl)propanone,
2-hydroxy-2-methyl-1-(4-dodecylphenyl)propanone,
2-Hydroxy-1-{4-[4-(2-hydroxy-2-methyl-propionyl)-benzyl]-phenyl}-2-methyl-propan-1-one and
2-hydroxy-2-methyl-1-[(2-hydroxyethoxy)phenyl]propanone.

The present α-hydroxy ketone photoinitiator is for example α-hydroxycyclohexylphenyl ketone or 2-hydroxy-2-methyl-1-phenyl-1-propanone. Straight or branched chain alkyl is for example, methyl, ethyl, propyl, isopropyl, butyl, isobutyl, sec-butyl, tert-butyl, pentyl, isopentyl, isooctyl, hexyl, heptyl, octyl, nonyl, decyl or dodecyl. Likewise, alkoxy or alkylthio are of the same straight or branched chains.

Photoinitiators according to the present invention may be employed singularly or in combination of one or more as a blend. Suitable photoinitiator blends (PI blends) are for example disclosed in U.S. Pat. No. 6,020,528 and U.S. Pat. app. No. 60/498,848. The present PI (photoinitiator) blends are for example a mixture of bis(2,4,6-trimethylbenzoyl)phenylphosphine oxide (CAS #162881-26-7) and 2,4,6,-trimethylbenzoylethoxyphenylphosphine oxide (CAS #84434-11-7) in ratios by weight of about 1:11, 1:10, 1:9, 1:8 or 1:7.

Another especially suitable PI blend is a mixture of bis(2,4,6-trimethylbenzoyl)phenylphosphine oxide, 2,4,6,-trimethylbenzoylethoxyphenylphosphine oxide and 2-hydroxy-2-methyl-1-phenyl-1-propanone (CAS #7473-98-5) in weight ratios of for instance about 3:1:15 or 3:1:16 or 4:1:15 or 4:1:16. Another suitable PI blend is a mixture of bis(2,4,6-trimethylbenzoyl)phenylphosphine oxide and 2-hydroxy-2-methyl-1-phenyl-1-propanone in weight ratios of for instance about 1:3, 1:4 or 1:5. The present acylphosphine oxide PI or PI blend is present in the radiation-curable compositions from about 0.2 to about 10% by weight, based on the weight of the composition. For instance, the PI or PI blend is present from about 0.5 to about 8%, about 1 to about 7%, or about 2, 3, 4, 5 or 6% by weight based on the weight of the radiation-curable composition.

Other suitable photoinitiators according to this invention are for or example, other mono- or bisacylphosphinoxides such as diphenyl-2,4,6-trimethylbenzoylphosphine oxide or bis(2,6-dimethoxybenzoyl)-2,4,4-trimethylpentylphosphineoxide; α-hydroxyketones, such as 1-hydroxycyclohexylphenylketone or 2-hydroxy-1-[4-(2-hydroxyethoxy)phenyl]-2-methyl-1-propanone; α-aminoketones, such as 2-methyl-1-[4-(methylthio)phenyl]-2-(4-morpholinyl)-1-propanone, 2-benzyl-2-(dimethylamino)-1-[4-(4-morpholinyl)phenyl]-1-butanone, 2-(4-methylbenzyl-2-(dimethylamino)-1-[4-(4-morpholinyl)phenyl]-1-butanone or 2-benzyl-2-(dimethylamino)-1-[3,4-dimethoxyphenyl]-1-butanone; benzophenones, such as benzophenone, 2,4,6-trimethylbenzophenone, 4-methylbenzophenone, 2-methylbenzophenone, 2-methoxycarbonylbenzophenone, 4,4′-bis(chloromethyl)-benzophenone, 4-chlorobenzophenone, 4-phenylbenzophenone, 4,4′-bis(dimethylamino)-benzophenone, 4,4′-bis(diethylamino)benzophenone, methyl2-benzoylbenzoate, 3,3′-dimethyl-4-methoxybenzophenone, 4-(4-methylphenylthio)benzophenone, 2,4,6-trimethyl-4′-phenyl-benzophenone or 3-methyl-4′-phenyl-benzophenone; ketal compounds, for example 2,2-dimethoxy-1,2-diphenyl-ethanone; and monomeric or dimeric phenylglyoxylic acid esters, such as methylphenylglyoxylic acid ester, 5,5′-oxo-di(ethyleneoxydicarbonylphenyl) or 1,2-(benzoylcarboxy)ethane.

Other suitable photoinitiators employed according to this invention, with or without acylphosphine oxide photoinitiators, are for example oxime esters as disclosed in U.S. Pat. No. 6,596,445. A suitable oxime ester photoinitiator is for example:

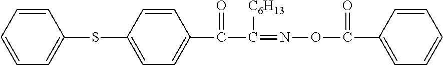

Another class of suitable photoinitiators according to this invention, with or without acylphosphine oxide photoinitiators, are for example phenyl glyoxalates, for example as disclosed in U.S. Pat. No. 6,048,660. For example phenyl glyoxalates of the formula:

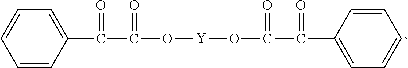

wherein Y is C₁-C₁₂alkylene, cyclohexlyene, C₂-C₄₀alkylene interrupted one or more times by cyclohexylene, O, S, or NR₃₀, and R₃₀ is hydrogen, C₁-C₁₂alkyl or phenyl, preferably Y is CH₂CH₂—O—CH₂CH₂.

One or more of the aforementioned free-radical photoinitiators can be employed in compositions according to the present invention in any suitable amount and may be chosen singly or in combination of one or more of the types enumerated herein. In a preferred embodiment, the free-radical photoinitiator component is present in an amount, relative to the entire weight of the composition, of from about 0.1 wt. % to about 10 wt. %, more preferably from about 0.1 wt. % to about 5 wt. %, more preferably from about 1 wt. % to about 5 wt. %.

### Fillers

Compositions according to the present invention also contain a filler component. Fillers are described in, e.g., U.S. Pat. No. 9,228,073 B2, which is hereby incorporated by reference in its entirety as if fully set forth herein.

### Additives

Additives are also typically added to optical fiber coatings to achieve certain desirable characteristics such as improved shelf life, improved coating oxidative and hydrolytic stability, and the like. There are many different types of desirable additives, and the invention discussed herein is not intended to be limited by these, nevertheless they are included in the envisioned embodiments since they have desirable effects.

Examples of these are thermal inhibitors, which are intended to prevent premature polymerization, examples being hydroquinone, hydroquinone derivatives, p-methoxyphenol, beta-naphthol or sterically hindered phenols, such as 2,6-di(tert-butyl)-p-cresol. The shelf life in the dark can be increased, for example, by using copper compounds, such as copper naphthenate, copper stearate or copper octoate, phosphorus compounds, for example triphenylphosphine, tributylphosphine, triethyl phosphite, triphenyl phosphite or tribenzyl phosphite, quaternary ammonium compounds, such as tetramethylammonium chloride or trimethylbenzylammonium chloride.

In order to keep out atmospheric oxygen during the polymerization, paraffin or similar wax-like substances can be added; these migrate to the surface on commencement of the polymerization because of their low solubility in the polymer, and form a transparent surface layer which prevents the ingress of air. It is likewise possible to apply an oxygen barrier layer.

Light stabilizers which can be added are UV absorbers, for example well known commercial UV absorbers of the hydroxyphenylbenzotriazole, hydroxyphenyl-benzophenone, oxalamide or hydroxyphenyl-s-triazine type. It is possible to use individual such compounds or mixtures thereof, with or without the use of sterically hindered relatively non-basic amine light stabilizers (HALS). Sterically hindered amines are for example based on 2,2,6,6-tetramethylpiperidine. UV absorbers and sterically hindered amines are for example:

2-(2-Hydroxyphenyl)-2H-benzotriazoles, for example known commercial hydroxyphenyl-2H-benzotriazoles and benzotriazoles as disclosed in, U.S. Pat. Nos. 3,004,896; 3,055,896; 3,072,585; 3,074,910; 3,189,615; 3,218,332; 3,230,194; 4,127,586; 4,226,763; 4,275,004; 4,278,589; 4,315,848; 4,347,180; 4,383,863; 4,675,352; 4,681,905, 4,853,471; 5,268,450; 5,278,314; 5,280,124; 5,319,091; 5,410,071; 5,436,349; 5,516,914; 5,554,760; 5,563,242; 5,574,166; 5,607,987, 5,977,219 and 6,166,218 such as 2-(2-hydroxy-5-methylphenyl)-2H-benzotriazole, 2-(3,5-di-t-butyl-2-hydroxyphenyl)-2H-benzotriazole, 2-(2-hydroxy-5-t-butylphenyl)-2H-benzotriazole, 2-(2-hydroxy-5-t-octylphenyl)-2H-benzotriazole, 5-chloro-2-(3,5-di-t-butyl-2-hydroxyphenyl)-2H-benzotriazole, 5-chloro-2-(3-t-butyl-2-hydroxy-5-methylphenyl)-2H-benzotriazole, 2-(3-sec-butyl-5-t-butyl-2-hydroxyphenyl)-2H-benzotriazole, 2-(2-hydroxy-4-octyloxyphenyl)-2H-benzotriazole, 2-(3,5-di-t-amyl-2-hydroxyphenyl)-2H-benzotriazole, 2-(3,5-bis-α-cumyl-2-hydroxyphenyl)-2H-benzotriazole, 2-(3-t-butyl-2-hydroxy-5-(2-(o-hydroxy-octa-(ethyleneoxy)carbonyl-ethyl)-, phenyl)-2H-benzotriazole, 2-(3-dodecyl-2-hydroxy-5-methylphenyl)-2H-benzotriazole, 2-(3-t-butyl-2-hydroxy-5-(2-octyloxycarbonyl)ethylphenyl)-2H-benzotriazole, dodecylated 2-(2-hydroxy-5-methylphenyl)-2H-benzotriazole, 2-(3-t-butyl-2-hydroxy-5-(2-octyloxycarbonylethyl)phenyl)-5-chloro-2H-benzotriazole, 2-(3-tert-butyl-5-(2-(2-ethylhexyloxy)-carbonylethyl)-2-hydroxyphenyl)-5-chloro-2H-benzotriazole, 2-(3-t-butyl-2-hydroxy-5-(2-methoxycarbonylethyl)phenyl)-5-chloro-2H-benzotriazole, 2-(3-t-butyl-2-hydroxy-5-(2-methoxycarbonylethyl)phenyl)-2H-benzotriazole, 2-(3-t-butyl-5-(2-(2-ethylhexyloxy)carbonylethyl)-2-hydroxyphenyl)-2H-benzotriazole, 2-(3-t-butyl-2-hydroxy-5-(2-isooctyloxycarbonylethyl)phenyl-2H-benzotriazole, 2,2′-methylene-bis(4-t-octyl-(6-2H-benzotriazol-2-yl)phenol), 2-(2-hydroxy-3-α-cumyl-5-t-octylphenyl)-2H-benzotriazole, 2-(2-hydroxy-3-t-octyl-5-α-cumylphenyl)-2H-benzotriazole, 5-fluoro-2-(2-hydroxy-3,5-di-α-cumylphenyl)-2H-benzotriazole, 5-chloro-2-(2-hydroxy-3,5-di-α-cumylphenyl)-2H-benzotriazole, 5-chloro-2-(2-hydroxy-3-α-cumyl-5-t-octylphenyl)-2H-benzotriazole, 2-(3-t-butyl-2-hydroxy-5-(2-isooctyloxycarbonylethyl)phenyl)-5-chloro-2H-benzotriazole, 5-trifluoromethyl-2-(2-hydroxy-3-α-cumyl-5-t-octylphenyl)-2H-benzotriazole, 5-trifluoromethyl-2-(2-hydroxy-5-t-octylphenyl)-2H-benzotriazole, 5-trifluoromethyl-2-(2-hydroxy-3,5-di-t-octylphenyl)-2H-benzotriazole, methyl 3-(5-trifluoromethyl-2H-benzotriazol-2-yl)-5-t-butyl-4-hydroxyhydrocinnamate, 5-butylsulfonyl-2-(2-hydroxy-3-α-cumyl-5-t-octylphenyl)-2H-benzotriazole, 5-trifluoromethyl-2-(2-hydroxy-3-α-cumyl-5-t-butylphenyl)-2H-benzotriazole, 5-trifluoromethyl-2-(2-hydroxy-3,5-dit-butylphenyl)-2H-benzotriazole, 5-trifluoromethyl-2-(2-hydroxy-3,5-di-α-cumylphenyl)-2H-benzotriazole, 5-butylsulfonyl-2-(2-hydroxy-3,5-di-t-butylphenyl)-2H-benzotriazole and 5-phenylsulfonyl-2-(2-hydroxy-3,5-di-t-butylphenyl)-2H-benzotriazole.

2-Hydroxybenzophenones, for example the 4-hydroxy, 4-methoxy, 4-octyloxy, 4-decyloxy, 4-dodecyloxy, 4-benzyloxy, 4,2′,4′-trihydroxy and 2′-hydroxy-4,4′-dimethoxy derivatives.

Esters of substituted and unsubstituted benzoic acids, as for example 4-tert-butylphenyl salicylate, phenyl salicylate, octylphenyl salicylate, dibenzoyl resorcinol, bis(4-tert-butylbenzoyl) resorcinol, benzoyl resorcinol, 2,4-di-tert-butylphenyl 3,5-di-tert-butyl-4-hydroxybenzoate, hexadecyl 3,5-di-tert-butyl-4-hydroxybenzoate, octadecyl 3,5-di-tert-butyl-4-hydroxybenzoate, 2-methyl-4,6-di-tert-butylphenyl 3,5-di-tert-butyl-4-hydroxybenzoate.

### Other Additives

To accelerate the photopolymerization it is possible to add accelerators, coinitiators and autoxidizers such as thiols, thioethers, disulfides and phosphines, as are described, for example, in EP-A-438 123 and GB-A-2 180 358.

The photopolymerization can also be accelerated by the addition of photosensitizers, which shift or broaden the spectral sensitivity. These are, in particular, aromatic carbonyl compounds, such as benzophenone derivatives, thioxanthone derivatives, anthraquinone derivatives and 3-acylcoumarin derivatives, and also 3-(aroylmethylene)thiazolines, and also eosine, rhodamine and erythrosine dyes. Alternatively, non-aromatic carbonyl compounds may be used. An example of a non-aromatic carbonyl is dimethoxy anthracene.

The curing procedure can be assisted, in particular, by compositions which are pigmented (for example with titanium dioxide), and also by adding a component which forms free radicals under thermal conditions, for example an azo compound such as 2,2′-azobis(4-methoxy-2,4-dimethylvaleronitrile), a triazene, a diazo sulfide, a pentazadiene or a peroxy compound, such as a hydroperoxide or peroxycarbonate, for example t-butyl hydroperoxide, as described in U.S. Pat. No. 4,753,817. Further suitable for this purpose include benzopinacol compounds.

The novel compositions can also include a photo reducible dye, for example xanthene, benzoxanthene, benzothioxanthene, thiazine, pyronine, porphyrin or acridine dyes, and/or a trihalomethyl compound which can be cleaved by radiation. Similar compositions are described, for example, in U.S. Pat. No. 5,229,253.

Other conventional additives may be used depending on the intended application. Examples include fluorescent whiteners, pigments, dyes, wetting agents or levelling assistants. Thick and pigmented coatings can also contain glass microbeads or powdered glass fibers, as described in U.S. Pat. No. 5,013,768, for example.

One or more of the aforementioned additives can be employed in compositions according to the present invention in any suitable amount and may be chosen singly or in combination of one or more of the types enumerated herein. In a preferred embodiment, the additive component is present in an amount, relative to the entire weight of the composition, of from about 0.01 wt. % to about 5 wt. %, more preferably from about 0.1 wt. % to about 2 wt. %. According to another embodiment, the one or more of the aforementioned additives are included in an amount from about 1 wt. % to about 5 wt. %.

### Configuring Primary Coating Compositions for Improved Thermal Resistivity

Inventors have presently discovered that traditional radiation curable primary coating compositions of the types described herein, and especially the oligomer components, are typically characterized by non-Newtonian rheological behavior. That is, they are shear thinning, or exhibit a reduction of shear viscosity at a high shear rate. Furthermore, such materials are highly temperature dependent; that is, the composition's viscosity is significantly influenced by its temperature. Inventors have found that the combination of these properties results in materials which are particularly sensitive to high temperature, high shear rate conditions, such as those experienced in high draw speed or low helium fiber optic coating processes.

This particular sensitivity results in coatings which become exponentially adversely affected by increasing levels of thermal shock or stress to the primary coating, exemplified by the situation wherein a relatively hot freshly drawn glass fiber moving at a high rate of speed comes into contact with a relatively cool, static radiation curable primary coating composition. Specifically, given the temperature dependence of the shear viscosity, upon application to a hot glass optical fiber, the so-called viscous heating effect creates a thin layer of low-viscous fluid close to the fiber. This phenomenon, which may be conceptually analogized to the rapid insertion of a hot knife through butter, results in a strong reduction of the drag capacity of the resin inside the corresponding applicator die, as well as a strong reduction of the coating thickness.

Furthermore, Inventors have discovered that conventional fiber optic coating applicator die designs leave a significant fraction of the die volume in a closed loop vortex. This leads to long residence times of the average quantum of primary coating composition in a die before application. Such die designs exacerbate the aforementioned problems because they lead to the phenomenon that while the local temperature of the resin is increased by the work done by viscous heating, the material inside the vortex will not be refreshed and will increase in temperature until a balance is reached between cooling by heat conduction in the fluid and heating by viscous dissipation.

The foregoing phenomena result in problems of impermissibly thin primary coatings, primary coatings with runout/concentricity issues, primary coatings with bubbles or defects, or those that improperly adhere to the glass, resulting in delamination issues.

In view of its understanding of the mechanics of the foregoing, Inventors have presently recognized that it is possible to improve the suitability of a primary coating composition for use in high draw speed or low helium optical fiber coating processes by reducing its viscosity sensitivity as a function of temperature. That is, such a material, if its relative viscosity were plotted as a function of temperature, should exhibit a flattened or reduced slope.

Inventors have discovered that appropriate “curve flattening” can be achieved by tuning the composition's viscosity ratio. As used herein, viscosity ratio is a measure of the steady-state shear viscosity (at a shear rate of 10 s⁻¹) of the same composition at two different temperatures, wherein the first temperature is lower than the second temperature. Unless otherwise noted, as used herein, “viscosity,” along with all qualifiers (such as “first viscosity,” “second viscosity,” or “third viscosity,” etc.) shall be assumed to mean the steady-state shear viscosity at a shear rate of 10 s⁻¹, and all units shall be expressed in terms of Pascal seconds unless otherwise noted. In an embodiment, the viscosity ratio is the composition's viscosity at 25° C. divided by that same composition's viscosity at 55° C. In another embodiment, the viscosity ratio is the composition's viscosity at 25° C. divided by that same composition's viscosity at 85° C. Although temperature conditions of optical fiber coating processes at high draw speeds or low helium utilization will vary, 55° C. is chosen because it is an operating temperature at which existing primary coating compositions have been observed to fail. It is believed that 85° C. is an even more effective marker, because: (1) this higher value will more finely discriminate between marginally-performing and high-performing coatings, and (2) it reflects a temperature to which coatings will foreseeably rise during the ever more demanding optical fiber processing conditions required for higher throughput and/or reduced helium consumption. Thus, compositions possessing viscosity ratios below select values may be sufficiently thermally resistive to be suitable in high draw speed/low helium coating processes.

In an embodiment wherein 85° C. is selected as the upper point in determining temperature sensitivity, the composition possesses a ratio of the viscosity at 25° C. to the viscosity at 85° C. of less than 15, or less than 10, or less than 9, or less than 8, or less than 7, or less than 6, or less than 5, and greater than 2.5, or greater than 2.7, or greater than 2.8, or greater than 3, or greater than 4, or from 2.6 to 10, or form 2.6 to 9, or from 2.6 to 8, or from 2.6 to 7. The above values and ratios may be exact, or alternatively reference an approximation of each stated value (i.e. +5%, or “about” each value).

In an embodiment wherein 55° C. is selected as the upper point in determining temperature sensitivity, the composition possesses a ratio of the viscosity at 25° C. to the viscosity at 55° C. of less than 5, or less than 4, or less than 3.5, or less than 3.3, or less than 3.1, or less than 3, or less than 2.9, or less than 2.7 or less than 2.5, or less than 2.3, or less than 2.1. In an embodiment, the ratio of the viscosity at 25° C. to 55° C. is a range from about 2 to about 5, or from about 2 to about 4, or from about 2 to about 3.5, or from about 2 to about 3. The above values and ratios may be exact, or alternatively reference an approximation of each stated value (i.e. +5%, or “about” each value).

If the viscosity ratio is too high, as has been observed in all heretofore existing optical fiber primary coatings, the composition will be characterized by an undesirably marked sensitivity to changes in temperature, which will result in inferior glass application and/or curing performance under high-temperature/high-speed processing. Therefore, the composition should be tuned according to the methods described herein to ensure that the viscosity ratio is as low as possible, whilst maintaining viability as an optical fiber coating.

In addition to possessing the requisite viscosity ratios, a primary coating composition should also possess a sufficiently high viscosity at higher operating temperatures, such as 55° C. That is, the primary coating must exhibit both a sufficiently low slope in terms of the temperature/viscosity relationship, but also an appropriately high “y-intercept” as well. A primary coating composition which possesses a sufficiently low viscosity ratio (i.e. relatively temperature insensitive or temperature/viscosity independent) might still not be suitable for use in coating optical fibers if it possessed an initial viscosity that was too low for feasible use. Therefore, according to certain embodiments, Inventors have discovered that an additional constraint upon thermally resistant primary coating compositions according to the current invention is that such compositions should possess a viscosity at the fiber application temperature of at least 0.01 pascal seconds (Pa·s), or greater than 0.10 Pa·s, or less than 20 Pa·s, or less than 1 Pa·s, or between about 0.01 Pa·s to about 20 Pa·s, or between about 0.01 Pa·s to about 1 Pa·s, or from about 0.03 Pa·s to about 1 Pa·s, or from about 0.03 Pa·s to about 0.8 Pa·s, or from about 0.03 Pa·s to about 0.5 Pa·s, or from about 0.03 Pa·s to about 0.4 Pa·s, or from about 0.05 Pa·s to about 1 Pa·s, or from about 0.05 Pa·s to about 0.5 Pa·s, or from about 0.1 Pa·s to about 1 Pa·s, or from about 0.1 Pa·s to about 0.8 Pa·s. In an embodiment, the application temperature is 55° C. In another embodiment, the application temperature is 85° C.

The viscosity of the composition at room temperature may also be a suitable indicator as to whether it will possess an appropriate flow resistance at a specified application temperature. Compositions that possess a viscosity that is too low at room temperature will more likely be insufficiently viscous at an application temperature. Therefore, in an embodiment, the viscosity of the primary coating composition, when measured at 25° C. is greater than 4 Pa·s, or greater than 5 Pa·s, or from 5 Pa·s to 100 Pa·s, or from 5 Pa·s to 50 Pa·s, or from 5 Pa·s to 20 Pa·s, or from 5 Pa·s to 12 Pa·s, or from 5 Pa·s to 10 Pa·s, or from 8 Pa·s to 50 Pa·s, or from 8 Pa·s to 20 Pa·s, or from 8 Pa·s to 12 Pa·s.

Inventors have found that the degree of a primary coating composition's suitability for use in high draw speed/low helium optical fiber coating processes is correlated with its expected time-temperature superposition performance as measured by the Williams-Landel-Ferry (or WLF) equation. The temperature dependence of the relaxation time (tau) associated with the glass transition of amorphous polymeric materials follows the so-called Williams, Landel and Ferry (WLF) relationship¹:

$$log ( τ ( T ) ) = log ( τ ( {T}_{r e f} ) ) - \frac{{C}_{1} * ( T - {T}_{r e f} )}{{C}_{2} + T - {T}_{r e f}} \qquad ( 1 )$$

In which τ(T) is the relaxation time of the glass transition of the polymeric material at temperature T, τ(T_{ref}) the relaxation time of the glass transition of the polymeric material at a reference temperature T_{ref}, and C₁ and C₂ are constants. The values of C₁ and C₂ depend on the chosen reference temperature. It has been described in literature that ‘universal’ values for C₁=17.44 and C₂=51.6 can be used for a broad range of polymeric materials when the reference temperature is chosen equal to the glass transition temperature (T_{g}), wherein T_{g} is determined via dynamic scanning calorimetry in a method described in McCrum, Read and Williams, An elastic and Dielectric Effects in Polymeric Solids, John Wiley & Sons, New York, 1967. To the finding of the Inventors, however, the viscosity of the uncured optical fiber coating resin formulations can be appropriately described with:

$$log ( η ( T ) ) = log ( η ( {T}_{g} ) ) - \frac{15 * ( T - {T}_{g} )}{{C}_{2} + T - {T}_{g}} \qquad ( 2 )$$

In which η(T) is the viscosity of the liquid at temperature T (as used herein, T is expressed in degrees Celsius unless otherwise noted), η(T_{g}) the viscosity at the glass transition temperature T_{g} as determined with DSC, the constant C₁ has a fixed value of 15 and C₂ is a fitting parameter that varies over a limited range of values between 35 and 45. Thus, the WLF equation for the liquid resin viscosity follows the same temperature dependence as the relaxation time of the glass transition, with a similar value of C₁ and a slightly lower value for C₂. Inventors also found that upon choosing a fixed value of 37.5 for C₂ in this equation, the glass transition of the liquid resin (Tg,rheo) can be determined from the resin viscosity versus temperature which is especially useful when data from DSC are not available. Given the limited range of C₂ values found when using actual Tg data from DSC this means that the glass transition temperature as determined from rheology agrees with the values from DSC within at most ±5° C., which is herein considered to be an acceptable accuracy.

For calculating the Tg from rheology, therefore, the standardized equation may be applied as follows:

$$log ( η ( T ) ) = log ( η ( {T}_{g , r h e o} ) ) - \frac{15 * ( T - {T}_{g , r h e o} )}{37.5 + T - {T}_{g , r h e o}} \qquad ( 3 )$$

The uncured liquid optical fiber coating resin formulations according to this invention have a lower temperature sensitivity of the resin viscosity in comparison with state of the art resin formulations, as measured from the ratios η(25° C.)/η(55° C.) and/or η(25° C.)/η(85° C.). For that purpose, it is useful to transform equation (3) from Tg,rheo as reference temperature to a reference temperature of 25° C.

$$log ( η ( T ) / {η}_{25} ) = - \frac{{C}_{1 , T r e f = 25 ° C .} * ( T - 25 )}{{C}_{2 , T r e f = 25 ° C .} + T - 25} \qquad ( 4 )$$

The transformation of the WLF equation to a different reference temperature can be done by equating:

C_{1,Tref=25° C.}×C_{2,Tref=25° C.}=C_{1,Tref=Tg,rheo}×C_{2,Tref=Tg,rheo} (5)

and

C_{2,Tref=25° C.}−25=C_{2,Tref=Tg,rheo}−Tg,rheo (6).

The universal WLF equation with Tg-rheo as reference temperature (3) and the equivalent equation with 25° C. as reference temperature (4) can, by including equations (5) and (6), be combined into a single free parameter equation for fitting Tg,rheo to the relative viscosity curve at reference temperature 25° C.:

$$\begin{matrix}log ( η ( T ) / {η}_{25} ) = - \frac{15 * 37.5 / ( 37.5 + 25 - {T}_{g , r h e o} ) * ( T - 25 )}{37.5 + T - {T}_{g , r h e o}} \\ or & ( 7 ) \\ η ( T ) / {η}_{25} = 10 ( \frac{- 5 \; 62.5 / ( 6 \; 2.5 - {T}_{g , r h e o} ) * ( T - 25 )}{37.5 + T - {T}_{g , r h e o}} ) . & ( 8 )\end{matrix}$$

The foregoing is surprising and has directed inventors to solve the problem of providing compositions to be more processable at higher line speeds and/or lower helium content by formulating in a direction opposite of what was previously considered the appropriate formulation approach. The conventional approach to assure a coating would possess a higher viscosity at elevated temperature was to increase the viscosity of that resin. Such approach could be accomplished via, i.a., increasing the relative quantity of higher molecular weight components, such as the oligomer, or by selecting reactive diluent monomers with a higher viscosity. Such approaches, however, will typically result in an increase in the liquid glass transition temperature (Tg, rheo) of the coating. Taking into account the universal WLF description of the viscosity versus temperature according to equation (3), Inventors have found that such an approach would unexpectedly increase the composition's temperature sensitivity, resulting in a coating that, although possessing an initially higher viscosity at room temperature, would more readily degrade into a low-viscosity resin that is ill-suited for application under higher thermal loads. Therefore, Inventors have presently prescribed a counterintuitive approach of formulating resins in directions which have the effect of a reduction or maintenance of viscosity at room temperature (versus the best known existing solutions) and a reduction of the liquid coating glass transition temperature in order to yield a reduced viscosity sensitivity overall and assure increased processability at higher temperatures.

In addition to the discovery of the reasons for these phenomena, Inventors have devised solutions which enable the skilled artisan, when following certain guidelines prescribed herein (and further illustrated in the non-limiting examples), are able to readily tune or configure a radiation curable primary coating composition to within certain parameters (including viscosity ratio and viscosity at 25° C.) without undue experimentation, so as to mitigate the inherent detriments associated with high draw speed/low helium processing environments. Thus, inventors have surprisingly discovered that it is possible to configure a primary coating composition for increased thermal resistivity—and in turn suitability for use optical fiber coating processes operating at high line speeds or with low helium application—if certain characteristics of the resin are tuned. Several approaches may be utilized to formulating to meet this criterion, including: (1) selecting reactive diluent monomers with lower liquid glass transition temperatures; and/or (2) selecting oligomers with a lower liquid glass transition temperature. Though the glass transition temperature of uncured monomers is usually not specified by the manufacturer or readily determined, as noted, the viscosity of the monomer can serve as a first guideline for selection of appropriate types. That is, monomers with a low viscosity usually also possess a low glass transition temperature.

Additionally, Inventors have determined that a monomer's relative polarity is also a good indicator of its ability to reduce the glass transition temperature of a composition with which it is associated. Inventors have discovered that more polar monomers have been observed to contribute beneficially by tending to reduce, relative to apolar monomers, the liquid glass transition temperature of the composition with which they are associated, without a concomitant reduction in the composition's overall viscosity. As mentioned elsewhere herein, the relative polarity can be understood by a monomer's calculated Boltzmann-averaged dipole moment.

In the case of the oligomer, meanwhile, Inventors have found that a low oligomer Tg, rheo can be obtained by selecting building blocks (polyol, isocyanate and acrylate end-cap) with a low glass transition temperature. Since the diol typically has the lowest glass transition temperature, in an embodiment it is preferred to select diols with number average molecular weight of 4000 g/mol or more—especially if it is desired to simultaneously assure a sufficiently high initial viscosity value—and combine these with an adequate molar ratio of (di-)isocyanates to target mono-, di- or a higher number of polyol blocks containing polyether-urethane-acrylate oligomers. Additionally, Inventors have discovered that the oligomer chemistry has a significant impact on the liquid elasticity as measured by the so-called steady state compliance (Je) of the liquid. Narrowly distributed oligomer diols (e.g. from anionic polymerization) provide less elastic liquids. Additionally, polyols with a low entanglement molecular weight including e.g. PTGL and polytetrahydrofuran (PTHF) result in a higher liquid elasticity. Examples with high entanglement molecular weight and therefore less elastic liquids, by contrast, include polypropylene glycol (PPG) and ethyleneoxide-butyleneoxide copolymer (EOBO).

In order to control viscosity, meanwhile, it would be possible to modify the quantity or nature of the reactive diluent monomer as appropriate. Because this component is not expected to have a significant impact on the composition's elasticity, it may be tuned to enable appropriate starting viscosities as prescribed and claimed herein once sufficient temperature sensitivity or viscosity ratios are achieved.

First, due to the significant diluent effect of several preferred monomers having a low liquid glass transition temperature, it is often desirable or necessary to incorporate a large quantity of the oligomer component. Large quantities of the oligomer also help to induce favorable mechanical properties into the primary coating cured therefrom, so there exist multiple reasons to ensure a high content of the oligomer is present in several embodiments of the invention. In a preferred embodiment, therefore, the radiation curable composition contains at least 50 wt. % of a reactive oligomer component, or at least 55 wt. % of a reactive oligomer component, or at least 60 wt. %, or at least 65 wt. %, or at least 70 wt. %, or from 45-85 wt. %, or from 55 to 80 wt. %, or from 60 to 85 wt. %, or from 60 to 80 wt. %.

It is also possible to control viscosity via oligomer selection and/or synthesis method. Specifically, Inventors have surprisingly also discovered that depending upon the method of oligomer synthesis technique employed, it is possible to modify the viscosity of the composition with which such oligomer is associated independently of such composition's overall temperature resistance. Specifically, Inventors have observed that oligomers synthesized with certain molecular weight distributions tend to yield oligomers with a higher viscosity than the same theoretical oligomer created via methods of synthesis with other molecular weight distributions without inducing a significant impact upon the Tg, rheo of the radiation curable composition with which they were associated. Inventors observed that, by way of non-limiting example, an oligomer synthesized by an “inside-out” method yielded such optimal molecular weight distributions than the same oligomer created by an “outside-in” method of synthesis. Without wishing to be bound by any theory, Inventors believe this phenomenon occurs because such methods tend to create a distribution containing higher fractions of oligomers possessing larger molecular weights. It is believed that although such variants are able to impart changes in viscosity, they do not appreciably impact the overall liquid glass transition temperature because of their relatively low representation by weight relative to all oligomer variants present.

This tactic may be helpful to the formulator of a radiation curable primary composition for optical fiber coating applications because it enables the use of a broader class of formulation constituents that reduce the composition's liquid glass transition temperature but are otherwise not suitable for use because they result in compositions that are insufficiently viscous. Conversely, this understanding enables the formulator to decrease the viscosity without significant changes in the relative temperature resistance as desired as well.

Inventors have discovered that an appropriate way to characterize oligomers which tend to produce this desired effect is my defining those with prescribed Relative High Molecular Weight Ratios (RHMWR). As used herein, RHMWR is determined by calculation of derived values for peak molecular weight (Mp), Z-average molecular weight (Mz), and number average molecular weight (Mn) via the following formula (9):

$$RHMWR = \frac{M p - M z}{M n} \qquad ( 9 )$$

wherein Mp, Mz, and Mn are determined via a size exclusion chromatography (SEC) method.

In a preferred embodiment, therefore, the reactive oligomer possesses a RHMWR value from −0.3 to 3. In an embodiment, the reactive oligomer possesses a RHMWR value greater than −0.3, or greater than −0.1, or greater than 0, or greater than 0.05. In an embodiment, the reactive oligomer possesses a RHMWR value less than 3, or less than 2, or less than 1, or less than 0.8.

Any oligomer synthesis technique which tends to yield oligomers to within this aforementioned range is expected to facilitate higher viscosities without a detrimental impact upon the liquid glass transition temperature. Inventors have also surprisingly discovered that polydispersity is not a good indicator of this phenomenon, as it has been observed that differently-performing oligomers with different RHMWR values might still possess relatively similar polydispersity values. This is believed to be because for present purposes, the relevant differences in molecular weight distribution are most relevant in the higher (e.g. z− and z+1) moments of the molecular weight distribution. Because lower moments such as Mw and Mn are insufficiently sensitive to indicate such subtle but notable differences, other methods should be used.

Inventors have also surprisingly discovered that fillers can be employed to increase viscosity without sacrificing the viscosity ratios of the compositions with which they are associated.

The foregoing configuration guidelines can be utilized singularly or in combination of two or more, and in any event do not represent an exhaustive list. Others, including additional already-known formulation guidelines, are appreciated by the skilled artisan and may be used as is exigent given the particular requirements of the application and process for which the primary coating composition is to be associated.

A third aspect of the invention is a coated optical fiber comprising a primary coating, wherein the primary coating is the cured product of the radiation curable composition according to any of the embodiments of the second aspect.

A fourth aspect of the invention is a method for producing a coated optical fiber comprising the steps of drawing a glass optical fiber through a draw tower; applying a primary coating composition onto the surface of the glass optical fiber; optionally, imparting a dose of UV light sufficient to at least partially cure said primary coating composition; applying a secondary coating composition to the primary coating composition; exposing the primary coating composition and the secondary coating composition to at least one radiation source capable of emitting ultraviolet radiation to affect curing of said primary coating composition and said secondary coating composition, to form a cured primary coating on the surface of the optical fiber, and a cured secondary coating on the surface of the cured primary coating; wherein the primary coating composition or the secondary coating composition, or both, comprises a reactive oligomer comprising at least one polymerizable group and a backbone; a reactive diluent monomer; a photoinitiator; a filler component; and optionally, one or more additives; wherein the radiation curable composition possesses a liquid glass transition temperature (Tg,rheo), a first viscosity at 25° Celsius (C) (η₂₅), a second viscosity at 55° C. (η₅₅), and a third viscosity at 85° C. (η₈₅); wherein, the ratio of the first viscosity to the third viscosity is less than 15, or less than 10, or less than 9, or less than 8, or less than 7, or less than 6, or less than 5, and greater than 2.5, or greater than 2.7, or greater than 2.8, or greater than 3, or greater than 4, or from 2.6 to 10, or form 2.6 to 9, or from 2.6 to 8, or from 2.6 to 7.

Another embodiment of the fourth aspect describes optical fiber coating processes according to one or more of the following conditions: at a draw speed of greater than 1500 m/min, or greater than 1700 m/min, or greater than 2000 m/min, or greater than 2500 m/min, or greater than 3000 m/min, and less than 5000 m/min, or less than 4000 m/min, or less than 3100 m/min; or under the application of no helium, or the application of helium at a flow rate of less than 20 standard liters per minute (SLM), or less than 10 SLM, or less than 5 SLM, or from 1 to 20 SLM, or from 1 to 10 SLM, or from 1 to 5 SLM, or from 5 to 20 SLM, or from 5 to 10 SLM.

A fifth aspect of the invention is an optical fiber cable, wherein the optical fiber comprises at least one optical fiber according to the first or third aspects of the invention, wherein the optical fiber is the cured product of a composition according to the second aspect of the invention, and/or wherein the optical fiber was coated according to the fourth aspect of the invention.

Improved resins of the current invention can be formulated via the selection of components specified above herein, and further readily tuned by those of ordinary skill in the art to which this invention applies by following the formulation guidelines herein, as well as by extrapolating from the general approaches taken in the embodiments illustrated in the examples below. The following such examples further illustrate the invention but, of course, should not be construed as in any way limiting its scope.

### EXAMPLES

These examples illustrate embodiments of the instant invention. Tables 1A and 1B describe the various components of the compositions used in the present examples. Table 2 describes the relative amounts of the reagents described in Tables 1A and 1B which were used to synthesize the oligomers used in the present examples.

TABLE 1A
Oligomer Components

| | | Supplier/ |
|---|---|---|
| Component | Chemical Descriptor | Manufacturer |
| Acclaim 8200 | Diol based on propylene Oxide; | Covestro |
| | molecular weight approximately 8,000 | |
| IPDI | Isophorone diisocyanate; | Evonik |
| | CAS 4098-71-9 | |
| HEA | 2-Hydroxyethyl acrylate; | Nippon |
| | CAS 818-61-1 | Shokubai |
| BHT Food | Butylated hydroxytoluene; | Lanxess |
| Grade | CAS 000128-37-0 | |
| DBTDL | Dibutyltin dilaurate; CAS 77-58-7 | Evonik |

TABLE 1B
Other Formulation Components

| | | Supplier/ |
|---|---|---|
| Component | Chemical Descriptor | Manufacturer |
| AEROSIL ® R 972 | hydrophobic fumed silica after | Evonik |
| | treated with DDS | |
| | (Dimethyldichlorosilane) | |
| AEROSIL ® R 974 | Hydrophobic fumed silica, BET | Evonik |
| | surface area 150-190 m²/g | |
| AEROSIL ® 200 | Hydrophilic fumed silica, BET | Evonik |
| | surface area 200 ± 25 m²/g | |
| Cab-O-Sil ® TS530 | Hydrophobic fumed silica treated | Cabot |
| | with hexamethyldisilazane | Corporation |
| EHA | 2-ethylhexyl acrylate; | Sigma-Aldrich |
| | CAS 103-11-7 | |
| TPO | 2,4,6-Trimethylbenzoyldiphenyl- | BASF |
| | phosphine oxide; CAS 75980-60-8 | |

TABLE 2
Oligomer Reactants

| Component | Oligomer 1a | Oligomer 1b |
|---|---|---|
| Acclaim 8200 | 91.97 | 91.97 |
| IPDI | 5.21 | 5.21 |
| HEA | 2.72 | 2.72 |
| BHT Food Grade | 0.05 | 0.05 |
| DBTDL | 0.05 | 0.05 |
| Polyol Equivalents | 2 | 2 |
| Isocyanate Equivalents | 4 | 4 |
| Acrylate Equivalents | 2 | 2 |
| Theoretical Molecular Weight | 8524 | 8524 |
| Polyether Block Nature of copolymer | Monoblock | Monoblock |
| Date of synthesis | September 2018 | October 2018 |

### Synthesis of Oligomers 1a and 1b

First, the relevant polyol (Acclaim 8200), after measured to ensure the quantities specified in Table 2A above, was added under a dry air blanket to a clean and dry flask, followed by the specified quantity of the inhibitor (BHT Food Grade). Next, the specified quantity of the isocyanate component (IPDI) was added. These reagents were mixed and stirred for about 15 minutes. Next, the specified quantities of the relevant catalyst (DBTDL) was added to the same flask and mixed for approximately an additional 15 minutes. The resulting mixture was then reacted at 60° C. for 1 hour in a heating mantle.

After the 1-hour reaction, the quantity of isocyanate (NCO) content was measured by a potentiometric titrator to ensure it was within 10% of the value of the theoretical isocyanate content that would be derivable for each oligomer from the quantities specified in Table 2A above. Upon confirmation of the appropriate isocyanate content, the appropriate amount of hydroxy ethyl acrylate was added to each oligomer, after which the resulting mixture was reacted for 1 hour at 85° C. Here, again, the isocyanate content was checked via potentiometric titration; if the isocyanate content was beyond 10% of the theoretical value, the mixture was placed back in the reaction chamber in 15-minute additional increments (again at 85° C.) and checked again, with this step repeated until the isocyanate content fell to within the desired range.

### Examples 1-13

Next, mixtures of oligomer, monomer(s) and photo-initiator were weighed in non-transparent polypropylene cups at 10-20 g scale. The mixing was performed at room temperature in a so-called speed-mixer (Brand Hauschild type DAC 150FVZ) for 5 minutes at 3000-3500 rpm. The temperature during mixing increased by a maximum of 10° C. If the (solid) photo-initiator was not completely dissolved visually, the mixing procedure was repeated. Samples were stored in the same cups.

The samples containing a filler component were created by starting with the base formulation consisting of the oligomer, monomer constituents, and photoinitiator prepared as described above. Then, the filler was added to the base formulation via different means depending on the dispersing equipment used as described below.

When the ultrasonic probe was used, for the preparation of the mixture with the filler, a 15 ml glass rolled bottle was nearly fully filled with an exactly weighed amount of the included filler. Next, the weighed amount of the base resin formulation was added in an amount needed to obtain the desired weight ratio of the filler in the final mixture (as prescribed per formulation in Table 3a below). The accuracy of the weighing was controlled so as to ensure an accuracy of the filler weight fraction in the final formulation of better than or equal to ±0.01%. The probe of the sonicator was used as mixing-rod through the bottle with resin to homogenize the content on a macro-level, subsequently the sample was treated with the sonicator for 15 seconds. Subsequently, the sonicator was used for 15 additional seconds. This process was repeated 6 times over a total period of 15 minutes.

When the Speedmixer was used, the desired amount of filler was manually mixed with resin in non-transparent polypropylene cups at 10-20 g scale with a spatula. Subsequently, mixing was performed in the Speedmixer at a maximum of 3500 rpm for 5-10 min, or until a homogenous mixture was yielded.

When the Speedmixer+Dispermat was used, a homogenous mixture of filler with resin were prepared similar as described in the paragraph above at a 100 g scale. Subsequently, the mixture was loaded in a stainless-steel beaker with an internal diameter of 70 mm. The material was treated with the Dispermat according to the conditions specified below.

The bottle with filler and resin was then subjected to mixing/dispersion according to different conditions and using different equipment as detailed in Table 3b below. Where “Dispermat” is indicated in Table 3b, a “DISPERMAT® Laboratory Dissolver-Mixer Model 2075 Yellow-Line equipped with a 35 mm heavy-duty stainless steel dispersion impeller/dissolver disk was used. Where “Speedmixer” is denoted in Table 3b, a Hauschild DAC150FVZ bladeless Speedmixer™ was used. The mixing speeds and total duration of mixing for each sample using such equipment is described further in Table 3b. Mixing was performed at room temperature, under atmospheric conditions.

Finally, for the example in Table 3b utilizing the “Ultrasonic Probe” (i.e. Dispersing Condition “E”), an ultrasonic probe (standard 1% z” solid probe by Sonics & Materials Inc., made of a titanium alloy TI-6Al-4V, which was operated at 40% of its capacity) was used. For the dispersing condition utilizing the ultrasonic probe, the mixing/dispersion was performed in three steps. After a first round of 15 seconds of ultrasonic mixing, the ultrasonic probe was then removed a few times and subsequently reinserted into the mixture to obtain additional macroscopic mixing of the sample. Finally, a further 15 minutes of ultrasonic agitation was applied. Mixing was performed at room temperature, under atmospheric conditions.

These samples were next tested according to the methods described below for determining each composition's steady state viscosity at 25°, 55°, and 85° (all values in degrees Celsius unless otherwise stated). These values are reported in Table 3a as η₂₅, η₅₅, and η₈₅, respectively. The values are presented as rounded to two decimal places, with the exception of values that were less than 0.10 Pascal seconds; such values are presented as rounded to three decimal places. The temperature sensitivity of each composition was also reported, in terms of the ratio of the steady state viscosity from 25° C. to 55° C., and also from 25° C. to 85° C. These values are reported in Table 3a as

$$\frac{{η}_{25}}{{η}_{55}} and \frac{{η}_{25}}{{η}_{85}} ,$$

respectively. The values for

$$\frac{{η}_{25}}{{η}_{55}} and \frac{{η}_{25}}{{η}_{85}} ,$$

are calculated using the non-rounded values of η₂₅, η₅₅, and η₈₅, and are reported to two decimal places. Finally, the liquid glass transition temperature of each sample was also determined by using the calculation method described herein. Such values are reported as rounded to one decimal place.

### Measurement of the Steady State Viscosity at 25, 55 and 85° C.

General Description: A general description of the measurement of the steady state shear viscosity of resins can be found in ISO 3219 “Plastics—Polymers/resins in the liquid state or as emulsions or dispersions—Determination of viscosity using a rotational viscometer with defined shear rate.” For the analysis of the steady state shear viscosity of uncured optical fiber coating formulations according to the invention, the rotational rheometer should be equipped with a measurement geometry to be adequately sensitive for the determination of the viscosity at a deformation rate of 10 s⁻¹ at temperatures between at least 20° C. and 90° C. Care needs to be taken to avoid evaporation of components of the sample under investigation during the course of the experimental procedure to a level that it affects the results of the measurement beyond the typical accuracy of the experiment of +/−5%. Though not limiting, the following preferred set-up for performing such measurements is described herein below.

Equipment: An Anton Paar type Physica MCR501 instrument was used for these experiments. This rheometer was equipped with a C-PTD200 temperature controller device consisting of a Peltier cooler/heater for use with concentric cylinder and double-gap measuring systems. The so-called double gap DG26.7 system was used as the measurement geometry.

Sample preparation and loading: A disposable plastic pipette (7 ml) was used to load the liquid into the sample cylinder of the double-gap geometry at room temperature, holding the geometry under an angle of about 45 degrees. This was used to prevent the inclusion of large air-bubbles in the double-gap geometry.

Next, about 6 ml of the liquid to be investigated was loaded into the double gap geometry, thus obtaining a complete filling of the measurement cell, and assuring the correctness of the sample-geometry surface area values. This amount of material was required to ensure full emersion of the bob of the double gap geometry in the liquid (i.e. the geometry was slightly overloaded with this amount of sample).

Atmosphere and shielding of the sample under investigation: Measurements were performed under air. To minimize evaporation of components from the sample under investigation, the liquid top surface was covered inside the geometry with the top-cap of a solvent trap system that was attached to the bob of the double-gap geometry.

Measurement: Next, a measurement protocol was followed that consisted of the following consecutive sequences:
1. The temperature was set to 20° C. for a duration of 15 minutes, without shearing or data collection to allow for temperature equilibration of the sample and geometry.
2. Perform a step-temperature steady shearing test sequence from 20 to 90° C. using temperature intervals of 5° C. and a shear rate 10 s⁻¹. After heating to the next temperature equilibrate for 10 minutes without shearing, the steady shear measurement was started using a shear rate 10 s⁻¹, after which 15 data points were acquired using a measurement duration per data point of 6 seconds. The average of these data points was then taken as value for the viscosity at the particular measurement temperature. This sequence was repeated up to a measurement temperature of 90° C. Finally, the data points from these results were extracted for the viscosities at 25, 55 and 85° C.
   The following (optional) measurement sequences were also added for a consistency check of the viscosity data obtained from the step temperature measurement sequence. Such steps specifically were incorporated to check that changes to the liquid viscosity e.g. due to evaporation during the measurements could be neglected:
3. Upon completion of the step-temperature sequence, the temperature was set to 85° C., for a duration of 10 minutes, without shearing or data collection to allow for temperature equilibration of the sample and geometry.
4. Next, a steady shear measurement using a shear rate 10 s⁻¹ was started, after which 15 data points were acquired using a measurement duration per data point of 6 seconds. The average of the acquired data points was taken and then verified that they coincided with the viscosity at 85° C. as determined by the step-temperature steady shearing measurement previously performed within an accuracy of 10%.
5. Next, the temperature was set to 55° C. for a duration 15 minutes, without shearing or data collection to allow for temperature equilibration of the sample and geometry.
6. After this, an additional steady shear measurement was started using a shear rate 10 s⁻¹, and 15 data points were acquired using a measurement duration per data point of 6 seconds each. The average of the acquired data points was then established, with this value verified that it coincided with the viscosity at 55° C. as determined with the step-temperature steady shearing measurement previously performed within an accuracy of 10%.
7. Additionally, the temperature was then set to 25° C. for a duration 15 minutes, without allowing for any shearing or data collection, to ensure temperature equilibration of the sample and geometry.
8. Finally, an additional steady shear measurement was started using a shear rate 10 s⁻¹, after which 15 data points were acquired using a measurement duration per data point of 6 seconds each. The average of these acquired data points were then taken and checked to verify that they coincided with the viscosity at 25° C. as determined by the step-temperature steady shearing measurement previously performed within an accuracy of 10%.

The above procedure was applied to each of the examples, with viscosity values at 25° C. reported as η₂₅, viscosity values at 55° C. reported as η₅₅, and viscosity values at 85° C. reported as η₈₅. The results are depicted in Table 3a below.

### Temperature Sensitivity of the Liquid Resin Viscosity (Tg, Rheo)

The values reported under the heading “Tg, rheo” are curve-fit calculations, which are a result of the application of one or more of expressions (1) through (8) of the Williams-Landel-Ferry equation to the actual rheology data (the method for obtaining which is explained above), reported in Tables 3A, 3B, 3C, and 4. Preferably, simplified equation (8) may be used:

$$η ( T ) / {η}_{25} = 10 ( \frac{- 5 \; 62.5 / ( 62.5 - {T}_{g , r h e o} ) * ( T - 25 )}{37.5 + T - {T}_{g , r h e o}} ) , \qquad ( 8 )$$

where η(T) is the viscosity of the composition at temperature, T, and η₂₅ is the first viscosity.

As used above, η(T) means the entirety of the viscosity data measured between 20° C. and 90° C., from which the viscosity at 25° C. (η₂₅) is used as the reference value. Next, a non-linear regression fit was applied to determine the value of Tg, rheo that provided the best overall fit of the calculated WLF fit to the experimental data. This was implemented in a Microsoft Excel® sheet using the Solver add-in. The results for each of the examples are depicted in Table 3a below.

TABLE 3a
Examples 1-13. Amounts are listed in parts by weight. Viscosity values are reported in pascal seconds (Pa·s); ratios are unitless.

| | | | | Monomer | | | | | | | | | | Tg, |
|---|---|---|---|---|---|---|---|---|---|---|---|---|---|---|
| Example | Oligomer | Oligomer Amount | Monomer 1 | 1 Amount | Filler Type | Filler Amount | TPO | Dispersing Condition | η₂₅ | η₅₅ | η₈₅ | $\frac{{η}_{25}}{{η}_{55}}$ | $\frac{{η}_{25}}{{η}_{85}}$ | rheo ° C.) |
| 1 | lb | 60 | EHA | 40 | | 0 | 1 | n/a | 0.69 | 0.23 | 0.11 | 2.99 | 6.32 | -113.2 |
| 2 | lb | 60 | EHA | 40 | Aerosil | 4.8 | 1 | A | 1.40 | 0.43 | 0.20 | 3.24 | 6.88 | -107.8 |
| | | | | | R972 | | | | | | | | | |
| 3 | lb | 60 | EHA | 40 | Aerosil | 4.8 | 1 | B | 1.31 | 0.41 | 0.20 | 3.17 | 6.64 | -109.6 |
| | | | | | R972 | | | | | | | | | |
| 4 | lb | 60 | EHA | 40 | Aerosil | 4.8 | 1 | C | 1.25 | 0.40 | 0.19 | 3.13 | 6.56 | -110.4 |
| | | | | | R972 | | | | | | | | | |
| 5 | la | 60 | EHA | 40 | | 0 | 1 | n/a | 0.98 | 0.32 | 0.15 | 3.06 | 6.60 | -111.1 |
| 6 | la | 60 | EHA | 40 | Aerosil | 4.8 | 1 | D | 1.92 | 0.58 | 0.27 | 3.30 | 7.05 | -106.5 |
| | | | | | R972 | | | | | | | | | |
| 7 | la | 60 | EHA | 40 | | 0 | 1 | n/a | 0.97 | 0.31 | 0.15 | 3.07 | 6.62 | -110.8 |
| 8 | la | 60 | EHA | 40 | Aerosil | 4.8 | 1 | E | 1.60 | 0.51 | 0.26 | 3.11 | 6.19 | -111.7 |
| | | | | | R972 | | | | | | | | | |
| 9 | lb | 60 | EHA | 40 | Aerosil | 2.5 | 1 | F | 1.01 | 0.33 | 0.16 | 3.02 | 6.20 | -113.2 |
| | | | | | R974 | | | | | | | | | |
| 10 | lb | 60 | EHA | 40 | Aerosil | 4.8 | 1 | F | 1.51 | 0.53 | 0.29 | 2.85 | 5.18 | -120.8 |
| | | | | | R974 | | | | | | | | | |
| 11 | lb | 60 | EHA | 40 | Aerosil | 10 | 1 | F | 4.51 | 1.86 | 1.67 | 2.42 | 2.71 | -169.5 |
| | | | | | R974 | | | | | | | | | |
| 12 | lb | 60 | EHA | 40 | Cab-o-Sil | 4.8 | 1 | F | 1.45 | 0.57 | 0.39 | 2.53 | 3.70 | -143.6 |
| | | | | | TS530 | | | | | | | | | |
| 13 | lb | 60 | EHA | 40 | Aerosil | 4.8 | 1 | F | 3.31 | 1.63 | 1.15 | 2.03 | 2.88 | -165.0 |
| | | | | | 200 | | | | | | | | | |

TABLE 3b
Filler component dispersing conditions

| Dispersing | | Speed- | Ultrasonic | | |
|---|---|---|---|---|---|
| Condition | Dispermat | mixer | Probe | RPM | Duration |
| A | Yes | No | No | 1865 | 3 min |
| B | Yes | No | No | 8400 | 3 min |
| C | Yes | No | No | 4600 | 3 min |
| D | No | Yes | No | Not | Not |
| | | | | applicable | applicable |
| E | No | No | Yes | Not | 6 × 15 sec |
| | | | | applicable | over period |
| | | | | | of 15 min |
| F | Yes | Yes | No | 6000 | 1-3 min |

### Discussion of Results

As can be witnessed from the data in Tables 3 compositions according to various aspects of the present invention exhibit reduced thermal sensitivity, as determined by the viscosity ratio

$$\frac{{η}_{25}}{{η}_{55}} and \frac{{η}_{25}}{{η}_{85}} ,$$

or alternatively via the liquid Tg of the material (Tg, rheo). Although not all examples possess commercially-known additives which are common in commercial primary coating compositions for optical fibers, their performance herein illustrates their suitability as at least a precursor composition for use in optical fiber coating applications wherein an increased amount of thermal stress is placed upon the applied coating, as such additives are not expected to significantly affect temperature sensitivity. Such increased thermal stresses could be induced by, for example, line speeds which are increased versus commercially standard values, or via the reduction or elimination of the amount of cooling (via helium flow or otherwise) fluid that is applied to the composition during the coating process.

From the data, it is apparent that certain types of fillers in certain quantities show remarkable improvements in Tg, rheo, while maintaining optimal resin viscosities. In particular, Examples 11 and 13 exhibited the lowest Tg, rheo values known to inventors for any composition useful for coating fiber optics.

Unless otherwise specified, the term wt. % means the amount by mass of a particular constituent relative to the entire liquid radiation curable composition into which it is incorporated.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventor for carrying out the invention. Variations of those preferred embodiments may become apparent to those of ordinary skill in the art upon reading the foregoing description. The inventor expects skilled artisans to employ such variations as appropriate, and the inventor intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

While the invention has been described in detail and with reference to specific embodiments thereof, it will be apparent to one of ordinary skill in the art that various changes and modifications can be made therein without departing from the spirit and scope of the claimed invention.

1. A radiation curable composition for coating an optical fiber comprising, relative to the total weight of the entire radiation curable composition:
a reactive oligomer comprising at least one polymerizable group and a backbone;
a reactive diluent monomer;
a photoinitiator;
a filler component; and
optionally, one or more additives;
wherein the radiation curable composition possesses a liquid glass transition temperature (Tg,rheo), a first viscosity at 25° Celsius (C) (η₂₅), a second viscosity at 55° C. (η₅₅), and a third viscosity at 85° C. (η₈₅);
wherein, the ratio of the first viscosity to the third viscosity is less than 15, or less than 10, or less than 9, or less than 8, or less than 7, or less than 6, or less than 5, and greater than 2.5, or greater than 2.7, or greater than 2.8, or greater than 3, or greater than 4, or from 2.6 to 10, or form 2.6 to 9, or from 2.6 to 8, or from 2.6 to 7.

2. A radiation curable composition for coating an optical fiber comprising, relative to the total weight of the entire radiation curable composition:
a reactive oligomer comprising at least one polymerizable group and a backbone;
a reactive diluent monomer;
a photoinitiator;
a filler component; and
optionally, one or more additives;
wherein the radiation curable composition possesses a liquid glass transition temperature (Tg,rheo), a first viscosity at 25° Celsius (C) (η₂₅), a second viscosity at 55° C. (η₅₅), and a third viscosity at 85° C. (η₈₅);
wherein
(1) the Tg,rheo of the radiation curable composition is less than −100° C., or less than −110° C., or less than −120° C., or from −170 to −100° C., wherein Tg,rheo is determined by fitting equation (8) to experimental viscosity versus temperature data for the radiation curable composition:
$$η ( T ) / {η}_{25} = 10 ( \frac{- 562.5 / ( 62.5 - {T}_{q , r h e o} ) * ( T - 25 )}{37.5 + T - {T}_{q , r h e o}} ) ,$$
where η(T) is the viscosity (in Pa·s) of the composition at temperature, T (in ° C.).

3. The radiation curable composition for coating an optical fiber according to any of claim 1, wherein the reactive oligomer comprises at least two polymerizable groups and a backbone derived from a polypropylene glycol.

4. The radiation curable composition for coating an optical fiber according to claim 1, wherein the filler component is present in an amount, relative to the weight of the entire composition, from 1 to 20 wt. %, or from 2 to 12 wt. %, or from 2.5 to 10 wt. %.

5. The radiation curable composition for coating an optical fiber according to claim 1, wherein the filler component comprises a plurality of silica nanoparticles or microparticles, or both.

6. The radiation curable composition for coating an optical fiber according to claim 1, wherein the filler component comprises hydrophilic silica particles.

7. The radiation curable composition for coating an optical fiber according to claim 1, wherein the filler component comprises hydrophobic silica particles.

8. The radiation curable composition for coating an optical fiber according to claim 1, wherein the composition is a primary coating composition.

9. The radiation curable composition for coating an optical fiber according to claim 1, wherein the composition is a secondary coating composition.

10. The radiation curable composition for coating an optical fiber according to claim 1, wherein the composition is a matrix composition.

11. The radiation curable composition according to claim 1, wherein the reactive diluent monomer comprises 2-ethylhexyl acrylate, 2-phenoxyethyl acrylate, 2-(2-ethoxyethoxy)ethyl acrylate, n-vinyl pyrrolidone, dimethylacryl-amide, n-vinylcaprolactam, ethoxylated 2-phenoxy ethyl acrylate, 4-hydroxy butyl acrylate, lauryl acrylate, isobornyl acrylate, caprolactone acrylate, ethoxylated nonylphenol acrylate, or isodecyl acrylate, or combinations thereof.

12. The radiation curable composition according to claim 1, wherein the reactive oligomer comprises a block copolymer comprising at least one polyether block, wherein the reactive oligomer possesses a monoblock structure, a diblock structure, or a triblock structure,
wherein a monoblock structure is defined as an average number from 0.9 to less than 1.5 polyether blocks per unreacted oligomer,
a diblock structure is defined as an average number of between 1.5 to less than 2.5 polyether blocks per unreacted oligomer, and
a triblock structure is defined as an average number of between 2.5 to less than 3.5 polyether blocks per unreacted oligomer.

13. The radiation curable composition according to claim 1, wherein the reactive oligomer is difunctional and possesses a weight average molecular weight from 8,000 g/mol to 25,000 g/mol.

14. The radiation curable composition according to claim 1, wherein a molar ratio of the compound derived from polypropylene glycol to the isocyanate is from 1:4 to 1:1, or from 1:2 to 3:4.

15. The radiation curable composition of claim 1, wherein the third viscosity is greater than 0.10 Pa·s, or less than 1 Pa·s, or between 0.01 Pa·s to 2 Pa·s.

16. The radiation curable composition of claim 1, wherein the filler component is added to the radiation curable composition by means of a Dispermat, a Speedmixer, or a Ultrasoon probe.

17. The radiation curable composition of claim 1, wherein the filler component is added to the radiation curable composition by means of a Dispermat and a Speedmixer.

18. The radiation curable composition of claim 1, wherein the filler component is mixed into the radiation curable composition at a speed of from 1800 to 5000 revolutions per minute.

19. The radiation curable composition of claim 1, wherein the filler component is mixed into the radiation curable composition for 3 minutes, or from 1 to 5 minutes.

20. The radiation curable composition of claim 1, wherein the composition comprises, relative to the entire weight of the composition:
from 60 wt. % to 82 wt. %, or from 65 wt. % to 80 wt. % of the reactive oligomer;
from 5 wt. % to 38 wt. %, or from 10 wt. % to 35 wt. % of the reactive diluent monomer;
from 1 wt. % to 5 wt. % of the photoinitiator;
from 2 wt. % to 10 wt. % of the filler component; and
from 1 wt. % to 5 wt. % of additives.
